(19) United States
(12) Patent Application Publication
(10) Pub. No.: US 2021/0138572 A1
(43) Pub. Date: May 13, 2021

(54) CLOSED-LOOP PRELOAD FOR WIRE FEEDING

(71) Applicant: Digital Alloys Incorporated, Burlington, MA (US)

(72) Inventors: Elad TAIG, Lexington, MA (US); Scott KILCOYNE, Cambridge, MA (US)

(21) Appl. No.: 17/098,588

(22) Filed: Nov. 16, 2020

Related U.S. Application Data
(63) Continuation of application No. PCT/US2019/037971, filed on Jun. 19, 2019.
(60) Provisional application No. 62/687,631, filed on Jun. 20, 2018.

(51) Int. Cl. B23K 9/12; B23K 9/133; B33Y 40/00; B33Y 50/02; B22F 12/50; B22F 10/85

(52) U.S. Cl. CPC B23K 9/125; B23K 9/1336; B33Y 40/00; B22F 10/22; B22F 12/50; B22F 10/85; B33Y 50/02

(57) ABSTRACT

The present disclosure provides a system for feeding a wire. The system may comprise a wire source configured to hold a wire. The system may comprise a driver roller configured to undergo rotation to direct the wire towards a wire receiver. The system may comprise a preload roller adjacent to the driver roller and configured to come in contact with the wire at a position adjacent to the driver roller. The preload roller and the driver roller may be separated by a gap. The size of the gap may be adjustable to permit the wire to be directed through the gap. The system may comprise an actuator coupled to the driver roller or the preload roller and configured to adjust the size of the gap. The system may comprise a controller operatively coupled to the actuator. The size of the gap may be adjusted by real-time closed-loop feedback.

### CROSS-REFERENCE

This application is a bypass continuation of International Patent Application No. PCT/US2019/037971, filed Jun. 19, 2019, which claims the benefit of U.S. Provisional Patent Application No. 62/687,631, filed Jun. 20, 2018, each of which is entirely incorporated herein by reference.

### BACKGROUND

Wire feeding techniques are widely used in a number of different applications including wire welding and additive manufacturing. A wire feeder may comprise a roller that is in contact (e.g., frictional contact) with a wire to advance the wire towards a wire receiver.

In a welding apparatus (e.g., an apparatus for gas metal arc welding or flux-cored arc welding), a wire feeder may be used to feed a wire from a wire source (e.g. a metal wire spool) to a nozzle of a welding gun. The welding gun may create heat to melt a portion of the wire and a work piece to form a pool of molten metal. The pool of molten metal may cool and solidify on the work piece. The pool of molten metal may join a plurality of work pieces.

Additive manufacturing techniques such as three-dimensional (3D) printing may also use wire feeding techniques. In an example, a polymeric material may be pulled by a wire feeder from a source into a nozzle, then melted, and subsequently deposited into a specified pattern in a layer-by-layer fashion to form a 3D object.

### SUMMARY

Recognized herein are various problems with current feedstock (e.g., a wire) feeding systems. In certain welding and three-dimensional (3D) printing applications, a feedstock may be fed through a gap between two rollers. A size of the gap may be adjusted manually to allow each of the two rollers to make a frictional contact with the feedstock. For example, the gap may be adjusted by rotating a knob that presses a first roller on the feedstock and towards a second roller. This may make it difficult to dynamically change the size of the gap during feedstock feeding (e.g., when the feedstock has varying cross-sectional dimensions, or when different feedstocks with different cross-sectional dimensions are used).

The present disclosure provides systems and methods of feedstock feeding that may help avoid various disadvantages of other feedstock feeding methods and systems. Systems and methods of the present disclosure may enable a feedstock to be directed from a source of the feedstock (e.g., a wire spool) to a feedstock receiver in a manner that reduces stress(es) imposed on the feedstock. This may advantageously increase the longevity of various components of systems of the present disclosure.

The present disclosure also provides rollers (e.g., a preload roller, a driver roller, etc.) that permit a wire to be directed from a source to a wire receiver (e.g., a nozzle of a welding unit (e.g., welding gun) or a guide of a 3D printing system) in a manner that reduces stress(es) on the wire while it is directed from the source to the wire receiver. Such rollers may be used to direct wires of different dimensions (e.g., diameters or sizes) or materials in a manner that adjusts stress(es) on the wire while it is in contact with the rollers.

The present disclosure further provides an adjusting mechanism for a gap between two or more rollers (e.g., two or more adjacent rollers) to permit a wire to be directed from a source to a wire receiver in a manner that reduces stress(es) on the wire or portions of the two or more rollers that are in contact with the wire.

In an aspect, the present disclosure provides a system for feeding a wire, comprising: (a) a wire source configured to hold a wire; (b) a driver roller configured to undergo rotation to direct the wire towards a wire receiver; (c) a preload roller adjacent to the driver roller and configured to come in contact with the wire at a position adjacent to the driver roller, wherein the preload roller and the driver roller are separated by a gap, and wherein a size of the gap is adjustable to permit the wire to be directed through the gap; (d) an actuator coupled to the driver roller or the preload roller and configured to adjust the size of the gap; and (e) a controller operatively coupled to the actuator, wherein the controller is configured to (i) direct the actuator to adjust the size of the gap and (ii) subject the driver roller to rotation to direct the wire towards the wire receiver.

In some embodiments, the actuator is coupled to the driver roller and the preload roller.

In some embodiments, the driver roller or the preload roller is mounted eccentrically with respect to an axis of rotation of the actuator. In some embodiments, the driver roller and the preload roller is mounted eccentrically with respect to an axis of rotation of the actuator.

In some embodiments, the actuator comprises a current sensor to measure an operating current of the actuator. In some embodiments, the actuator comprises a sensor. In some embodiments, the sensor detects movement of the actuator. In some embodiments, the controller is configured to direct at least the sensor to provide a real-time closed-loop feedback communication between (i) the driver roller or the preload roller and (ii) the actuator. In some embodiments, the controller is configured to provide the real-time closed-loop feedback communication between (i) the driver roller and the actuator and (ii) the preload roller and the actuator.

In some embodiments, the driver roller and the preload roller are configured to rotate in different directions while the wire is directed towards or away from the wire receiver.

In some embodiments, the driver roller further comprises an additional actuator. In some embodiments, the additional actuator is configured to subject the driver roller to rotation to direct the wire towards the wire receiver.

In some embodiments, the preload roller further comprises a sensor. In some embodiments, the sensor detects rotational movement of the preload roller.

In some embodiments, the driver roller is mechanically coupled to an additional actuator that subjects the driver roller to rotation, thereby to direct the wire towards the wire receiver. In some embodiments, the additional actuator may direct the wire towards the wire receiver at a given speed of a plurality of wire feed speeds.

In some embodiments, the wire receiver is a nozzle of a welding unit (e.g., welding gun) for wire welding. In some embodiments, the wire receiver is a nozzle of a printing head in a device for printing a three-dimensional (3D) object. In some embodiments, the wire is usable for the printing the 3D object.

In another aspect, the present disclosure provides a method of feeding a wire, comprising: (a) activating a wire feeding system, comprising: (i) a wire source configured to hold a wire; (ii) a driver roller configured to undergo rotation to direct the wire towards a wire receiver; (iii) a preload roller adjacent to the driver roller and configured to come in contact with the wire at a position adjacent to the driver roller, wherein the preload roller and the driver roller are separated by a gap, and wherein a size of the gap is adjustable to permit the wire to be directed through the gap; and (iv) an actuator coupled to the driver roller or the preload roller and configured to adjust the size of the gap; (b) adjusting the size of the gap; and (c) rotating the driver roller to direct the wire through the gap and towards the wire receiver.

In some embodiments, the actuator is coupled to the driver roller and the preload roller.

In some embodiments, the driver roller or the preload roller is mounted eccentrically with respect to an axis of rotation of the actuator. In some embodiments, the driver roller and the preload roller is mounted eccentrically with respect to an axis of rotation of the actuator.

In some embodiments, the actuator comprises a current sensor to measure an operating current of the actuator. In some embodiments, the actuator comprises a sensor. In some embodiments, the method further comprises using real-time closed-loop feedback from at least the sensor to measure a force exerted on the wire by the driver roller or the preload roller. In some embodiments, the method further comprises using the real-time closed-loop feedback from at least the sensor to measure the force exerted on the wire by the driver roller and the preload roller. In some embodiments, the method further comprises using real-time closed-loop feedback to measure the wire cross-sectional dimensions during feeding the wire.

In some embodiments, the method further comprises rotating the driver roller and the preload roller in different directions while the wire is directed towards or away from the wire receiver.

In some embodiments, the driver roller further comprises an additional actuator. In some embodiments, the method further comprises directing the additional actuator to subject the driver roller to rotation, thereby to direct the wire towards the wire receiver.

In some embodiments, the preload roller further comprises a sensor. In some embodiments, the method further comprises using the sensor to detect rotational movement of the preload roller.

In some embodiments, the driver roller is mechanically coupled to an additional actuator that subjects the driver roller to rotation, thereby to direct the wire towards the wire receiver. In some embodiments, the additional actuator may direct the wire towards the wire receiver at a given speed of a plurality of wire feed speeds.

In some embodiments, the wire receiver is a nozzle of a welding unit (e.g., welding gun) for wire welding. In some embodiments, the wire receiver is a nozzle of a printing head in a device for printing a three-dimensional (3D) object. In some embodiments, the wire is usable for the printing the 3D object.

In another aspect, the present disclosure provides a system for printing a three-dimensional (3D) object, comprising: (a) a wire source configured to hold a wire, which wire is usable for the printing the 3D object; (b) a print head comprising a guide, which guide directs the wire from the wire source towards and in contact with a support or at least a portion of the 3D object adjacent to the support; (c) a driver roller configured to come in contact with the wire, wherein the driver roller is coupled to an actuator that subjects the driver roller to rotation to direct the wire towards the guide; (d) a preload roller adjacent to the driver roller and configured to come in contact with the wire at a position adjacent to the driver roller, wherein the preload roller and the driver roller are separated by a gap, wherein a size of the gap is adjustable to permit the wire to be directed through the gap; (e) a power source in electrical communication with the wire and the support, wherein the power source is configured to supply electrical current from the guide through the wire and to the support, or vice versa, during the printing; and (f) a controller in electrical communication with the power source, wherein the controller is configured to (i) direct adjustment of the size of the gap, (ii) direct the actuator to direct the wire through the gap and towards the guide, and (iii) direct the power source to supply the electrical current from the guide through the wire and to the support, or vice versa, during the printing under conditions sufficient to melt the wire when the wire is in contact with the support or the portion of the 3D object.

In some embodiments, the driver roller comprises a groove that is configured to accept at least a portion of the wire. In some embodiments, the preload roller comprises a protrusion that is configured to position the at least the portion of the wire in the groove.

In some embodiments, the preload roller comprises a groove that is configured to accept at least a portion of the wire. In some embodiments, the driver roller comprises a protrusion that is configured to position the at least the portion of the wire in the groove.

In some embodiments, the driver roller comprises an additional actuator that adjusts the size of the gap. In some embodiments, the additional actuator comprises a current sensor to measure an operating current of the additional actuator, and the operating current is indicative of a contact force between the wire and the driver roller. In some embodiments, the additional actuator comprises a sensor. In some embodiments, the sensor detects movement of the additional actuator. In some embodiments, the controller is configured to provide a real-time closed-loop feedback communication between the driver roller and the additional actuator. In some embodiments, the driver roller is mounted eccentrically with respect to an axis of rotation of the additional actuator.

In some embodiments, the preload roller comprises an additional actuator that adjusts the size of the gap. In some embodiments, the additional actuator comprises a current sensor to measure an operating current of the additional actuator. In some embodiments, the operating current is indicative of a contact force between the wire and the driver roller. In some embodiments, the additional actuator comprises a sensor. In some embodiments, the sensor detects movement of the additional actuator. In some embodiments, the controller is configured to provide a real-time closed-loop feedback communication between the preload roller and the additional actuator. In some embodiments, the preload roller is mounted eccentrically with respect to an axis of rotation of the additional actuator.

In some embodiments, the driver roller and the preload roller are configured to rotate in different directions while the wire is directed towards or away from the guide.

In some embodiments, the preload roller further comprises a sensor. In some embodiments, the sensor detects rotational movement of the preload roller.

In some embodiments, the controller is in communication with the driver roller and the preload roller. In some embodiments, the controller is configured to adjust the size of the gap while the wire is directed towards or away from the guide.

In some embodiments, the actuator that is coupled to the driver roller may direct the wire towards the guide at a given speed of a plurality of wire feed speeds. In some embodiments, the plurality of wire feed speeds may range from 0.01 meters per second to 5 meters per second.

In some embodiments, the driver roller is connected to an electric motor for rotating the driver roller at a plurality of operating speeds. In some embodiments, the system further comprises a motor controller operatively coupled to the electric motor. In some embodiments, the motor controller is configured to accelerate, decelerate, maintain at a given speed of the plurality of operating speeds, or control direction of rotation of the electric motor.

In some embodiments, the system further comprises an assembly for directing the wire towards or away from the guide. In some embodiments, the assembly comprises the driver roller and the preload roller. In some embodiments, the assembly directs the wire from the wire source towards the guide. In some embodiments, the assembly directs the wire along a direction away from the guide towards the wire source.

In another aspect, the present disclosure provides a method for printing a three-dimensional (3D) object, comprising: (a) activating a 3D printing system, comprising: (i) a wire source configured to hold a wire, which wire is usable for printing the 3D object; (ii) a print head comprising a guide; (iii) a support to hold at least a portion of the 3D object; (iv) a driver roller configured to come in contact with the wire, wherein the driver roller is coupled to an actuator that subjects the driver roller to rotation to direct the wire towards the guide; and (v) a preload roller adjacent to the driver roller and configured to come in contact with the wire at a position adjacent to the driver roller, wherein the preload roller and the driver roller are separated by a gap, wherein a size of the gap is adjustable to permit the wire to be directed through the gap; (b) adjusting the size of the gap; (c) using the actuator to direct the wire through the gap and towards the guide; and (d) supplying electrical current from the guide through the wire and to the support, or vice versa, during the printing under conditions sufficient to melt the wire when the wire is in contact with the support or the portion of the 3D object.

In some embodiments, the method further comprises using real-time closed-loop feedback to measure a force exerted on the wire by the driver roller or the preload roller. In some embodiments, the method further comprises using the real-time closed-loop feedback to measure the force exerted on the wire by the driver roller and the preload roller. In some embodiments, the method further comprises using real-time closed-loop feedback to measure the wire cross-sectional dimensions during printing the 3D object.

In some embodiments, the driver roller comprises a groove that is configured to accept at least a portion of the wire. In some embodiments, the method further comprises directing the at least the portion of the wire into the groove of the driver roller. In some embodiments, the method further comprises directing the driver roller or the preload roller such that a protrusion of the preload roller positions the at least the portion of the wire into the groove of the driver roller. In some embodiments, the method further comprises directing the driver roller and the preload roller such that the protrusion of the preload roller positions the at least the portion of the wire into the groove of the driver roller.

In some embodiments, the preload roller comprises a groove that is configured to accept at least a portion of the wire. In some embodiments, the method further comprises directing the at least the portion of the wire into the groove of the preload roller. In some embodiments, the method further comprises directing the driver roller or the preload roller such that a protrusion of the driver roller positions the at least the portion of the wire into the groove of the preload roller. In some embodiments, the method further comprises directing the driver roller and the preload roller such that the protrusion of the driver roller positions the at least the portion of the wire into the groove of the preload roller.

In some embodiments, the method further comprises directing an additional actuator of the driver roller to adjust the size of the gap. In some embodiments, the method further comprises using a current sensor of the additional actuator to measure an operating current of the additional actuator, wherein the operating current is indicative of a contact force between the wire and the driver roller. In some embodiments, the method further comprises using a sensor of the additional actuator to detect movement of the additional actuator. In some embodiments, the method further comprises providing a real-time closed-loop feedback communication between the driver roller and the additional actuator. In some embodiments, the driver roller is mounted eccentrically with respect to an axis of rotation of the additional actuator.

In some embodiments, the method further comprises directing an additional actuator of the preload roller to adjust the size of the gap. In some embodiments, the method further comprises using a current sensor of the additional actuator to measure an operating current of the additional actuator, wherein the operating current is indicative of a contact force between the wire and the driver roller. In some embodiments, the method further comprises using a sensor of the additional actuator to detect movement of the additional actuator. In some embodiments, the method further comprises providing a real-time closed-loop feedback communication between the preload roller and the additional actuator. In some embodiments, the preload roller is mounted eccentrically with respect to an axis of rotation of the additional actuator.

In some embodiments, the method further comprises rotating the driver roller and the preload roller in different directions while the wire is directed towards or away from the guide. In some embodiments, the method further comprises using a sensor of the preload roller to detect rotational movement of the preload roller. In some embodiments, the method further comprises adjusting the size of the gap while the wire is directed towards or away from the guide. In some embodiments, the method further comprises directing an electric motor of the driver roller for rotating the driver roller at a plurality of operating speeds. In some embodiments, the method further comprises accelerating, decelerating, maintaining at a given speed of the plurality of operating speeds, or controlling direction of rotation of the electric motor.

In some embodiments, the driver roller and the preload roller are part of an assembly, and the method further comprises using the assembly to direct the wire towards or away from the guide. In some embodiments, the method further comprises using the assembly to direct the wire from the wire source towards the guide. In some embodiments, the method further comprises using the assembly to direct the wire along a direction away from the guide towards the wire source.

In another aspect, the present disclosure provides a method for forming a three-dimensional (3D) object, comprising: (a) providing a first roller separated from a second roller by an adjustable gap; (b) directing a wire through the adjustable gap and in contact with a support; and (c) using heat from within the wire to melt the wire when the wire is in contact with the support, to form the 3D object.

In some embodiments, the method further comprises directing electrical current from the wire to the support, or vice versa, to generate the heat.

In some embodiments, the method further comprises using the first roller or the second roller to direct the wire through the adjustable gap and in contact with the support.

In some embodiments, the method further comprises adjusting the adjustable gap prior to directing a wire through the adjustable gap and in contact with a support.

In another aspect, the present disclosure provides a system for forming a three-dimensional (3D) object, comprising: (a) a first roller separated from a second roller by an adjustable gap that permits a wire to pass therethrough and in contact with a support; and (b) a controller that (i) directs supply of the wire through the adjustable gap and in contact with the support, and (ii) directs generation of heat from within the wire to melt the wire when the wire is in contact with the support, to form the 3D object.

In some embodiments, the system further comprises a power supply in electrical communication with the wire and the support. In some embodiments, the controller directs the power supply to supply electrical current from the wire to the support, or vice versa, to generate the heat.

In some embodiments, the controller directs the first roller or the second roller to direct the wire through the adjustable gap and in contact with the support. In some embodiments, the controller directs the first roller and the second roller to direct the wire through the adjustable gap and in contact with the support.

In another aspect, the present disclosure provides a non-transitory computer readable medium comprising machine executable code that, upon execution by one or more computer processors, implements any of the methods above or elsewhere herein.

In another aspect, the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1D schematically illustrate a wire feeding assembly comprising a driver roller, a preload roller, and a gap adjusting actuator;

FIG. 2 illustrates a movement of the preload roller relative to the gap adjusting actuator;

FIG. 3 is a graph of an operating current and angular position of the gap adjusting actuator;

FIG. 4 schematically illustrates a three-dimensional printing system with multiple wire feeding assemblies;

FIG. 5 shows a computer system that is programmed or otherwise configured to implement methods provided herein; and

FIG. 6 schematically illustrates an example of a wire feeding method.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “at most”, “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “eccentric,” as used herein, generally refers to an element not being placed centrally, or not having an axis of other part placed centrally, with respect to another element. For example, a first circle that is encompassed by a second circle is eccentric with respect to the second circle by having a different axis of rotation than the second circle.

The term “welding,” as used herein, generally refers to a method of heating at least a portion of a feedstock (e.g., a metal wire) to form a pool of molten liquid (e.g., molten metal) on an object (e.g., a metal object). The pool of molten liquid may cool and solidify on the object. In some cases, the method may comprise heating the at least a portion of the feedstock and at least a portion of the object to form the pool of molten liquid.

The term “three-dimensional object” (also “3D object”), as used herein, generally refers to an object or a part that is printed by 3D printing. The 3D object may be at least a portion of a larger 3D object or an entirety of the 3D object.

The term “support,” as used herein, generally refers to a structure that supports a nascent 3D object during printing and supports the 3D object after printing. The support may be a platform or an object that may not be a platform, such as another 3D object. The other object may be an object in need of repair or an object that is to be fused to another object (e.g., by a welding-type approach).

The term “feedstock,” as used herein, generally refers to a material that is usable alone or in combination with other material to print a 3D object. In some examples, the feedstock may be (i) a wire, ribbon or sheet, (ii) a plurality of wires, ribbons or sheets, or (iii) a combination of two or more of wires, ribbons and sheets (e.g., combination of wires and ribbons). The feedstock may comprise at least one of polymers (e.g., thermoplastics), metals, metal alloys, ceramics, or mixtures thereof. The 3D printing may be performed with at least 1, 2, 3, 4, 5, 6, 7, 8, 9, 10, or more feedstocks.

The term “guide,” as used herein, generally refers to a component in a print head that guides a feedstock towards a location on which a 3D object is to be printed, such as into a melt zone adjacent to a support. The melt zone may be on a support or at least a portion of a 3D object. The guide may be a nozzle or a tip, for example. The guide may permit the feedstock to pass towards and in contact with the support. The guide may include an opening, and during use, the feedstock may be directed in contact with the guide through the opening and towards the support. As an alternative, the guide may not include an opening, but may include a surface that comes in contact with the feedstock. The feedstock may slide through, over or under the guide of the print head into the melt zone. The guide may make a sliding contact with the feedstock and conduct electrical current to or from the feedstock. The guide may constrain the feedstock radially. A position of the guide relative to the melt zone may be constrained while the feedstock is moving through the guide towards the melt zone.

In some cases, the term “guide,” as used herein, generally refers to a component in a welding unit (e.g., welding gun) that guides a feedstock (e.g. a metal wire) towards a location on which welding may occur. The guide may be a nozzle, for example. The feedstock may be a welding electrode.

The term “roller,” as used herein, generally refers to a part that may be in contact with a portion of a feedstock during printing. The roller may have various shapes and sizes. The roller may be circular, triangular, or square, for example. The roller may have at least one groove that is dimensioned to accommodate at least a portion of the feedstock. The roller may have at least one protrusion to come in contact with at least a portion of the feedstock. The roller may direct movement and/or direction of the feedstock during printing. The roller may contact and supply a force to the feedstock to maintain a tension on the feedstock between a feedstock source to the guide.

The present disclosure provides methods and systems for forming a 3D object. The 3D object may be based on a computer model of the 3D object, such as a computer-aided design (CAD) stored in a non-transitory computer storage medium (e.g., medium). As an alternative, the 3D object may not be based on any computer model. In such scenario, methods and systems of the present disclosure may be used to, for example, deposit material on another object, couple one object to at least another object (e.g., welding at least two objects together), or cure a defect in an object (e.g., fill a hole or other defect).

### Printing Systems and Methods

In an aspect, the present disclosure provides a system for printing a three-dimensional (3D) object. The system may comprise a feedstock source configured to hold a feedstock. The feedstock may be usable for printing the 3D object. The system may comprise a print head comprising a guide. The guide may direct the feedstock from the feedstock source towards and in contact with a support or at least a portion of the 3D object adjacent to the support. The system may comprise a driver roller configured to come in contact with the feedstock. The driver roller may be coupled to an actuator that subjects the driver roller to rotation to direct the feedstock towards the guide. The system may comprise a preload roller adjacent to the driver roller. The preload roller may be configured to come in contact with the feedstock at a position adjacent to the driver roller. The preload roller and the driver roller may be separated by a gap. A size of the gap may be adjustable to permit the feedstock to be directed through the gap. The system may comprise a power source in electrical communication with the feedstock and the support. The power source may be configured to supply electrical current from the guide through the feedstock and to the support, or vice versa, during printing the at least a portion of the 3D object. The system may also comprise a controller in electrical communication with the power source. The controller may be configured to direct adjustment of the size of the gap. The controller may be configured to direct the actuator coupled to the driver roller to direct the feedstock through the gap and towards the guide. The controller may be configured to direct the power source to supply the electrical current from the guide through the feedstock and to the support, or vice versa, during printing under conditions sufficient to melt the feedstock when the feedstock is in contact with the support or the portion of the 3D object.

The print head may move relative to the support. The print head may further comprise a mechanical gantry capable of motion in one or more axes of control (e.g., one or more of the XYZ planes) via one or more actuators. Many actuators may accomplish the required motion, including electric, hydraulic or pneumatic motors, linear actuators, belts, pulleys, lead screws, and other devices. The one or more actuators of the print head may be operatively connected to the controller. The controller may direct movement of the print head during printing the at least the portion of the 3D object.

The 3D printing may be performed with at least 1, 2, 3, 4, 5, 6, 7, 8, 9, 10, or more feedstocks. The 3D printing may be performed with at most 10, 9, 8, 7 ,6, 5, 4, 3, 2, or 1 feedstock. In some cases, a plurality of feedstocks may be used to print a layer of the 3D object. The feedstock may be (i) a wire, ribbon or sheet, (ii) a plurality of wires, ribbons or sheets, or (iii) a combination of two or more of wires, ribbons and sheets (e.g., combination of wires and ribbons). The feedstock may have other form factors. If multiple feedstocks are used, the multiple feedstocks may be brought together to the opening. Alternatively or in addition to, at least some or each of the multiple feedstocks may be directed to the opening or different openings. A cross-sectional diameter of the feed stock may be at least about 0.01 millimeters (mm), 0.02 mm, 0.03 mm, 0.04 mm, 0.05 mm, 0.06 mm, 0.07 mm, 0.08 mm, 0.09 mm, 0.1 mm, 0.15 mm, 0.2 mm, 0.25 mm, 0.3 mm, 0.35 mm, 0.4 mm, 0.45 mm, 0.5 mm, 1.0 mm, 1.5 mm, 2.0 mm, 2.5 mm, 3.0 mm, 3.5 mm, 4.0 mm, 5 mm, 6 mm, 7 mm, 8 mm, 9 mm, 10 mm or higher. Alternatively, the cross-sectional diameter may be less than or equal to 10 mm, 9 mm, 8 mm, 7 mm, 6 mm, 5 mm, 4.0 mm, 3.5 mm, 3.0 mm, 2.5 mm, 2.0 mm, 1.5 mm, 1.0 mm, 0.5 mm, 0.45 mm, 0.4 mm, 0.35 mm, 0.3 mm, 0.25 mm, 0.2 mm, 0.15 mm, 0.1 mm, 0.09 mm, 0.08 mm, 0.07 mm, 0.06 mm, 0.05 mm, 0.04 mm, 0.03 mm, 0.02 mm, 0.01 mm or less.

The feedstock may be formed of at least one metal. In some examples, the feedstock comprises one or more metals selected from the group consisting of steel, stainless steel, iron, copper, gold, silver, cobalt, chromium, nickel, titanium, platinum, palladium, titanium, and aluminum. The feedstock may include at least one non-metal, such as a fiber material (e.g., elemental fiber or nanotube) and/or polymeric material. The fiber material may include, for example, carbon fiber, carbon nanotubes, and/or graphene. Alternatively, the feedstock may include at least one natural or synthetic ceramic material. The natural or synthetic ceramic material may be calcium phosphate, calcium carbonate, or silicate.

Segments of the feedstock may be printed on the support by melting a tip of the feedstock with an electric current. The electric current may flow from the guide of the print head through the feedstock and to the support, or vice versa. When the tip of the feedstock is in contact with the support, an electric circuit comprising the guide of the print head, the feedstock, the support, and a power source may be formed. The controller may be operatively coupled to the power source. In such electric circuit, the feedstock may be a first electrode, and the support may be a second electrode. If the feedstock is in physical contact with the support and the power source supplies the electrical current from the guide through the feedstock and to the support, or vice versa, the feedstock and the support are in electrical contact. In the electrical contact, there may be an electrical resistance between the feedstock and the support (i.e., contact resistance) due to a small surface area of the feedstock and microscopic imperfections on a surface of the tip of the feedstock and/or a surface of the support. The contact resistance between the tip of the feedstock and the support may heat a local area at the contact according to Equation 1 (i.e., Joule's First Law):

Q=I²·R·t (Equation 1)

where Q is the heat generated at the local area at the contact,

I is the electric current,

R is the contact resistance between the feedstock and the support, and

t is a duration of an application of the current.

The heat generated at the local area at the contact between the feedstock and the support may be sufficient to melt the tip of the feedstock into a segment and to fuse the segment to the support. The heat may be generated by resistive heating (e.g., Joule heating). In some examples, the segment is a strand or a particle, which strand or particle may be molten. Upon deposition of the segment on the support, the segment may act as a second electrode in the electric circuit to melt and print additional segments of the feedstock. The heat generated at the local area may be sufficient to melt the tip of the feedstock into a segment and to fuse the segment to a segment on the support. The heat generated at the local area may be sufficient to melt the tip of the feedstock into a segment and to fuse the segment to one or more neighboring segments. As such, segments of the feedstock may be deposited without use or generation of electric arcs and/or plasma, but rather by utilizing energy (e.g., electrical energy) within the feedstock. The energy within the feedstock may be to (i) melt at least a portion of the feedstock and (ii) print and/or repair at least a portion of the 3D object.

The tip of the feedstock (e.g., a wire) may melt while the feedstock is in contact with the support and the feedstock and the support are moving relative to one another. For example, the feedstock is moving and the support is stationary. As another example, the feedstock is stationary and the support is moving (e.g., along a plane orthogonal to a longitudinal axis of the support perpendicular to the support). As another example, both the feedstock and the support are moving relative to one another (e.g., along a plane orthogonal to a longitudinal axis of the support perpendicular to the support).

The support may be printing platform. As an alternative, the support may be a previously deposited layer, such as a previously deposited layer of the three-dimensional object or a previously deposited sacrificial layer(s). As another alternative, the support is a part (e.g., part formed by 3D printing or other approaches) and the feedstock is deposited on the part.

The heat (or temperature) generated at the local area at the contact between the feedstock (e.g., a wire) and the support may be at least 100 degrees Celsius (° C.), 200° C., 300° C., 400° C., 500° C., 600° C., 700° C., 800° C., 900° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., 3000° C., 3100° C., 3200° C., 3300° C., 3400° C., 3500° C., 3600° C., 3700° C., 3800° C., 3900° C., 4000° C., 5000° C. or more. The heat generated at the local area at the contact between the feedstock and the support may be at most 5000° C., 4000° C., 3900° C., 3800° C., 3700° C., 3600° C., 3500° C., 3400° C., 3300° C., 3200° C., 3100° C., 3000° C., 2900° C., 2800° C., 2700° C., 2600° C., 2500° C., 2400° C., 2300° C., 2200° C., 2100° C., 2000° C., 1900° C., 1800° C., 1700° C., 1600° C., 1500° C., 1400° C., 1300° C., 1200° C., 1100° C., 1000° C., 900° C., 800° C., 700° C., 600° C., 500° C., 400° C., 300° C., 200° C., 100° C., or less.

In some cases, the heat generated at the local area at the contact between the feedstock and the support may not vary depending on a material of the feedstock (e.g., the wire). Alternatively, the heat generated at the local area at the contact between the feedstock and the support may vary depending on the material of the feedstock. In some examples, the heat may be at least about 400° C., 410° C., 420° C., 430° C., 440° C., 450° C., 460° C., 470° C., 480° C., 490° C., 500° C., 510° C., 520° C., 530° C., 540° C., 550° C., 560° C., 570° C., 580° C., 590° C., 600° C., 610° C., 620° C., 630° C., 640° C., 650° C., 660° C., 670° C., 680° C., 690° C., 700° C., 710° C., 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1000° C., 1110° C., 1120° C., 1130° C., 1140° C., 1150° C., 1160° C., 1170° C., 1180° C., 1190° C., 1200° C., 1210° C., 1220° C., 1230° C., 1240° C., 1250° C., 1260° C., 1270° C., 1280° C., 1290° C., 1300° C., or more when the feedstock comprises aluminum or alloys. The heat may be at most 1300° C., 1290° C., 1280° C., 1270° C., 1260° C., 1250° C., 1240° C., 1230° C., 1220° C., 1210° C., 1200° C., 1190° C., 1180° C., 1170° C., 1160° C., 1150° C., 1140° C., 1130° C., 1120° C., 1110° C., 1100° C., 1090° C., 1080° C., 1070° C., 1060° C., 1050° C., 1040° C., 1030° C., 1020° C., 1010° C., 1000° C., 990° C., 980° C., 970° C., 960° C., 950° C., 940° C., 930° C., 920° C., 910° C., 900° C., 890° C., 880° C., 870° C., 860° C., 850° C., 840° C., 830° C., 820° C., 810° C., 800° C., 790° C., 780° C., 770° C., 760° C., 750° C., 740° C., 730° C., 720° C., 710° C., 700° C., 690° C., 680° C., 670° C., 660° C., 650° C., 640° C., 630° C., 620° C., 610° C., 600° C., 590° C., 580° C., 570° C., 560° C., 550° C., 540° C., 530° C., 520° C., 510° C., 500° C., 490° C., 580° C., 470° C., 460° C., 450° C., 440° C., 430° C., 420° C., 410° C., 400° C., or less when the feedstock comprises aluminum or alloys.

In some examples, the heat may be at least 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1000° C., 1010° C., 1020° C., 1030° C., 1040° C., 1050° C., 1060° C., 100° C., 1080° C., 1090° C., 1100° C., 1110° C., 1120° C., 1130° C., 1140° C., 1150° C., 1160° C., 1170° C., 1180° C., 1190° C., 1200° C., 1210° C., 1220° C., 1230° C., 1240° C., 1250° C., 1260° C., 1270° C., 1280° C., 1290° C., 1300° C., 1310° C., 1320° C., 1330° C., 1340° C., 1350° C., 1360° C., 1370° C., 1380° C., 1390° C., 1400° C., 1410° C., 1420° C., 1430° C., 1440° C., 1450° C., 1460° C., 1470° C., 1480° C., 1490° C., 1500° C., 1510° C., 1520° C., 1530° C., 1540° C., 1550° C., 1560° C., 1570° C., 1580° C., 1590° C., 1600° C., or more when the feedstock comprises copper or alloys. The heat may be at most 1600° C., 1590° C., 1580° C., 1570° C., 1560° C., 1550° C., 1540° C., 1530° C., 1520° C., 1510° C., 1500° C., 1490° C., 1480° C., 1470° C., 1460° C., 1450° C., 1440° C., 1430° C., 1420° C., 1410° C., 1400° C., 1390° C., 1380° C., 1370° C., 1360° C., 1350° C., 1340° C., 1330° C., 1320° C., 1310° C., 1300° C., 1290° C., 1280° C., 1270° C., 1260° C., 1250° C., 1240° C., 1230° C., 1220° C., 1210° C., 1200° C., 1190° C., 1180° C., 1170° C., 1160° C., 1150° C., 1140° C., 1130° C., 1120° C., 1110° C., 1100° C., 1090° C., 1080° C., 1070° C., 1060° C., 1050° C., 1040° C., 1030° C., 1020° C., 1010° C., 1000° C., 990° C., 980° C., 970° C., 960° C., 950° C., 940° C., 930° C., 920° C., 910° C., 900° C., 890° C., 880° C., 870° C., 860° C., 850° C., 840° C., 830° C., 820° C., 810° C., 800° C., or less when the feedstock comprises copper or alloys.

In some examples, the heat may be at least 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1000° C., 1010° C., 1020° C., 1030° C., 1040° C., 1050° C., 1060° C., 1070° C., 1080° C., 1090° C., 1100° C., 1110° C., 1120° C., 1130° C., 1140° C., 1150° C., 1160° C., 1170° C., 1180° C., 1190° C., 1200° C., 1210° C., 1220° C., 1230° C., 1240° C., 1250° C., 1260° C., 1270° C., 1280° C., 1290° C., 1300° C., 1310° C., 1320° C., 1330° C., 1340° C., 1350° C., 1360° C., 1370° C., 1380° C., 1390° C., 1400° C., 1410° C., 1420° C., 1430° C., 1440° C., 1450° C., 1460° C., 1470° C., 1480° C., 1490° C., 1500° C., 1510° C., 1520° C., 1530° C., 1540° C., 1550° C., 1560° C., 1570° C., 1580° C., 1590° C., 1600° C., or more when the feedstock comprises gold or alloys. The heat may be at most 1600° C., 1590° C., 1580° C., 1570° C., 1560° C., 1550° C., 1540° C., 1530° C., 1520° C., 1510° C., 1500° C., 1490° C., 1480° C., 1470° C., 1460° C., 1450° C., 1440° C., 1430° C., 1420° C., 1410° C., 1400° C., 1390° C., 1380° C., 1370° C., 1360° C., 1350° C., 1340° C., 1330° C., 1320° C., 1310° C., 1300° C., 1290° C., 1280° C., 1270° C., 1260° C., 1250° C., 1240° C., 1230° C., 1220° C., 1210° C., 1200° C., 1190° C., 1180° C., 1170° C., 1160° C., 1150° C., 1140° C., 1130° C., 1120° C., 1110° C., 1100° C., 1090° C., 1080° C., 1070° C., 1060° C., 1050° C., 1040° C., 1030° C., 1020° C., 1010° C., 1000° C., 990° C., 980° C., 970° C., 960° C., 950° C., 940° C., 930° C., 920° C., 910° C., 900° C., 890° C., 880° C., 870° C., 860° C., 850° C., 840° C., 830° C., 820° C., 810° C., 800° C., or less when the feedstock comprises gold or alloys.

In some examples, the heat may be at least 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1000° C., 1050° C., 1100° C., 1150° C., 1200° C., 12050° C., 1300° C., 1350° C., 1400° C., 1450° C., 1500° C., 1550° C., 1600° C., 1650° C., 1700° C., 1750° C., 1800° C., 1850° C., 1900° C., 1950° C., 2000° C., 2050° C., 2100° C., 2150° C., 2200° C., 2250° C., 2300° C., 2350° C., 2400° C., 2450° C., 2500° C., or more when the feedstock comprises iron or alloys. The heat may be at most 2500° C., 2450° C., 2400° C., 2350° C., 2300° C., 2250° C., 2200° C., 2150° C., 2100° C., 2050° C., 2000° C., 1900° C., 1800° C., 1700° C., 1600° C., 1500° C., 1400° C., 1300° C., 1200° C., 1100° C., 1000° C., 990° C., 980° C., 970° C., 960° C., 950° C., 940° C., 930° C., 920° C., 910° C., 900° C., 890° C., 880° C., 870° C., 860° C., 850° C., 840° C., 830° C., 820° C., 810° C., 800° C., or less when the feedstock comprises iron or alloys.

In some examples, the heat may be at least 1500° C., 1510° C., 1520° C., 1530° C., 1540° C., 1550° C., 1560° C., 1570° C., 1580° C., 1590° C., 1600° C., 1610° C., 1620° C., 1630° C., 1640° C., 1650° C., 1660° C., 1670° C., 1680° C., 1690° C., 1700° C., 1710° C., 1720° C., 1730° C., 1740° C., 1750° C., 1760° C., 1770° C., 1780° C., 1790° C., 1800° C., 1850° C., 1900° C., 1950° C., 2000° C., 2050° C., 2100° C., 2150° C., 2200° C., 2250° C., 2300° C., or more when the feedstock comprises platinum or alloys. The heat may be at most 2300° C,2250° C,2200° C,2150° C,2100° C., 2050° C,2000° C,1950° C,1900° C,1850° C,1800° C., 1790° C., 1780° C., 1770° C., 1760° C., 1750° C., 1740° C., 1730° C., 1720° C., 1710° C., 1700° C., 1690° C., 1680° C., 1670° C., 1660° C., 1650° C., 1640° C., 1630° C., 1620° C., 1610° C., 1600° C., 1590° C., 1580° C., 1570° C., 1560° C., 1550° C., 1540° C., 1530° C., 1520° C., 1510° C., 1500° C., or less when the feedstock comprises platinum or alloys.

In some examples, the heat may be at least 1200° C., 1210° C., 1220° C., 1230° C., 1240° C., 1250° C., 1260° C., 1270° C., 1280° C., 1290° C., 1300° C., 1310° C., 1320° C., 1330° C., 1340° C., 1350° C., 1360° C., 1370° C., 1380° C., 1390° C., 1400° C., 1410° C., 1420° C., 1430° C., 1440° C., 1450° C., 1460° C., 1470° C., 1480° C., 1490° C., 1500° C., 1510° C., 1520° C., 1530° C., 1540° C., 1550° C., 1560° C., 1570° C., 1580° C., 1590° C., 1600° C., 1650° C., 1700° C., 1750° C., 1800° C., 1850° C., 1900° C., 1950° C., 2000° C., 2050° C., 2100° C., or more when the feedstock comprises steel (e.g., carbon steel, stainless steel, etc.). The heat may be at most 2100° C., 2050° C., 2000° C., 1950° C., 1900° C., 1850° C., 1800° C., 1750° C., 1700° C., 1650° C., 1600° C., 1590° C., 1580° C., 1570° C., 1560° C., 1550° C., 1540° C., 1530° C., 1520° C., 1510° C., 1500° C., 1490° C., 1480° C., 1470° C., 1460° C., 1450° C., 1440° C., 1430° C., 1420° C., 1410° C., 1400° C., 1390° C., 1380° C., 1370° C., 1360° C., 1350° C., 1340° C., 1330° C., 1320° C., 1310° C., 1300° C., 1290° C., 1280° C., 1270° C., 1260° C., 1250° C., 1240° C., 1230° C., 1220° C., 1210° C., 1200° C., or less when the feedstock comprises steel.

In some embodiments, based at least in part on a type or composition of the alloy, the melting point of the alloy may be lower than a melting temperature of one or more base metals of the alloy. Alternatively, based at least in part on a type or composition of the alloy, the melting point of the alloy may be higher than the melting temperature of the one or more base metals of the alloy. In another alternative, based at least in part on a type or composition of the alloy, the melting point of the alloy may be about the same as the melting temperature of the one or more base metals of the alloy. In some embodiments, the feedstock (e.g. a wire) may superheat at a melt pool.

The electric current from the guide to the feedstock and to the support, or vice versa, may range from about 10 Amperes (A) to about 20000 A. The electric current may be at least about 10 A, 20 A, 30 A, 40 A, 50 A, 60 A, 70 A, 80 A, 90 A, 100 A, 200 A, 300 A, 400 A, 500 A, 600 A, 700 A, 800 A, 900 A, 1000 A, 2000 A, 3000 A, 4000 A, 5000 A, 6000 A, 7000 A, 8000 A, 9000 A, 10000 A, 20000 A, or more. The electric current may be at most about 20000 A, 10000 A, 9000 A, 8000 A, 7000 A, 6000 A, 5000 A, 4000 A, 3000 A, 2000 A, 1000 A, 900 A, 800 A, 700 A, 600 A, 500 A, 400 A, 300 A, 200 A, 100 A, 90 A, 80 A, 70 A, 60 A, 50 A, 40 A, 30 A, 20 A, 10 A or less. The duration of the application of the current may range from about 0.01 seconds (s) to about 1 s. The duration of the application of the current may be at least about 0.01 s, 0.02 s, 0.03 s, 0.04 s, 0.05 s, 0.06 s, 0.07 s, 0.08 s, 0.09 s, 0.1 s, 0.2 s, 0.3 s, 0.4 s, 0.5 s, 0.6 s, 0.7 s, 0.8 s, 0.9 s, 1 s or more. The duration of the application of the current may be at most about 1 s, 0.9 s, 0.8 s, 0.7 s, 0.6 s, 0.5 s, 0.4 s, 0.3 s, 0.2 s, 0.1 s, 0.09 s, 0.08 s, 0.07 s, 0.06 s, 0.05 s, 0.04 s, 0.03 s, 0.02 s, 0.01 s or less.

The material for the support may be selected for good electrical conductivity and compatibility with the feedstock that is being deposited as segments. The material for the support may have a higher electrical conductivity than the feedstock. Alternatively or in addition to, the material for the support may have substantially the same or a lower electrical conductivity than the feedstock. The support may be non-consumable and thus need not be replaced during normal operation. Alternatively or in addition to, the support may be replaced after printing one or more 3D objects. The support may be chosen to allow weak adhesion of the deposited segments to it, so that a first layer of deposited segments may hold the at least the portion of the 3D object firmly in place on the support during further deposition. The material for the support may have a higher electrical conductivity than the feedstock. The material for the support may not alloy with the feedstock. The material for the support may have a higher thermal conductivity than the feedstock, such that heat generated at an area of the feedstock deposition may be quickly conducted away. For example, if the deposited metal is steel, copper or aluminum may be appropriate materials for the support. Alternatively or in addition to, the material for the support may have substantially the same or lower thermal conductivity than the feedstock to maintain the heat generated at the area of the feedstock deposition.

The application of electric current may be controlled to influence the deposition of segments (e.g., size, shape, etc.). An open-loop control of the electric current may be enabled via choosing a desired intensity level and/or duration of power prior to the deposition of segments. The desired intensity level and/or duration of power may be assigned on the power source or the controller operatively coupled to the power source. The desired intensity level of the power may be calibrated to achieve a specific voltage or current at a constant contact resistance between the feedstock and the support. Alternatively or in addition to, a closed-loop control may be used. The closed-loop control may comprise an electrical measurement meter (e.g., a voltmeter, ammeter, potentiometer, etc.) electrically coupled to the guide of the print head, the feedstock, the support, the power source, and/or the controller operatively coupled to the power source. In the closed-loop control, voltage and current to the tip of the feedstock may be measured in situ during deposition of the segments, and the contact resistance between the feedstock and the support may be calculated according to Equation 2 (i.e., Ohm's Law):

$$R = \frac{V}{I} \qquad ( Equation 2 )$$

where V is the voltage,
I is the electric current, and
R is the contact resistance between the feedstock and the support.
   The closed-loop control may beneficially eliminate failed parts due to incomplete fusion of segments and minimize heat input into the structure during deposition.

Because the contact resistance is calculated dynamically, the power of the applied electric current may be precisely controlled, thus resulting in an exact amount of heat being applied during deposition of a segment from the feedstock. The power source may supply an alternating current (AC) or a direct current (DC) to the feedstock and/or the support. The AC may range from about 1 millivolt (mV) to about 100 volt (V). The AC may be about at least about 1 mV, 2 mV, 3 mV, 4 mV, 5 mV, 6 mV, 7 mV, 8 mV, 9 mV, 10 mV, 20 mV, 30 mV, 40 mV, 50 mV, 60 mV, 70 mV, 80 mV, 90 mV, 100 mV, 200 mV, 300 mV, 400 mV, 500 mV, 600 mV, 700 mV, 800 mV, 900 mV, 1 V, 2 V, 3 V, 4 V, 5 V, 6 V, 7 V, 8 V, 9 V, 10 V, 20 V, 30 V, 40 V, 50 V, 60 V, 70 V, 80 V, 90 V, 100 V, or more. The AC may be at most about 100 V, 90 V, 80 V, 70 V, 60 V, 50 V, 40 V, 30 V, 20 V, 10 V, 9 V, 8 V, 7 V, 6 V, 5 V, 4 V, 3 V, 2 V, 1 V, 900 mV, 800 mV, 700 mV, 600 mV, 500 mV, 400 mV, 300 mV, 200 mV, 100 mV, 90 mV, 80 mV, 70 mV, 60 mV, 50 mV, 40 mV, 30 mV, 20 mV, 10 mV, 9 mV, 8 mV, 7 mV, 6 mV, 5 mV, 4 mV, 3 mV, 2 mV, 1 mV or less. The DC may range from about 1 mV to 100 V. The DC may be about at least about 1 mV, 2 mV, 3 mV, 4 mV, 5 mV, 6 mV, 7 mV, 8 mV, 9 mV, 10 mV, 20 mV, 30 mV, 40 mV, 50 mV, 60 mV, 70 mV, 80 mV, 90 mV, 100 mV, 200 mV, 300 mV, 400 mV, 500 mV, 600 mV, 700 mV, 800 mV, 900 mV, 1 V, 2 V, 3 V, 4 V, 5 V, 6 V, 7 V, 8 V, 9 V, 10 V, 20 V,30 V, 40 V, 50 V, 60 V, 70 V, 80 V, 90 V, 100 V, or more. The DC may be at most about 100 V, 90 V, 80 V, 70 V, 60 V, 50 V, 40 V, 30 V, 20 V, 10 V, 9 V, 8 V, 7 V, 6 V, 5 V, 4 V, 3 V, 2 V, 1 V, 900 mV, 800 mV, 700 mV, 600 mV, 500 mV, 400 mV, 300 mV, 200 mV, 100 mV, 90 mV, 80 mV, 70 mV, 60 mV, 50 mV, 40 mV, 30 mV, 20 mV, 10 mV, 9 mV, 8 mV, 7 mV, 6 mV, 5 mV, 4 mV, 3 mV, 2 mV, 1 mV or less.

In some examples, one pole of the power source is attached to the feedstock (e.g., through a guide of the print head) and another pole of the power source is attached to the support.

The system may comprise a wire feeding assembly (“assembly”) for directing or feeding the feedstock along the direction towards the guide of the print head, or a direction away from the guide towards the feedstock source. The assembly may comprise a first roller and a second roller. The first roller may be configured to come in contact with the feedstock. The second roller may be configured to come in contact with the feedstock at a position of the feedstock adjacent to the first roller. The first roller or the second roller may be coupled to an actuator that subjects the first roller or the second roller to rotation to direct the feedstock towards the guide. In some cases, the actuator may direct the feedstock towards the guide at a given speed of a plurality of feedstock feed speeds. In some cases, the plurality of feedstock feed speeds may range from about 0.01 meters per second (m/s) to about 5 m/s. The plurality of feedstock feed speeds may be at least about 0.01 m/s, 0.02 m/s, 0.03 m/s, 0.04 m/s, 0.05 m/s, 0.06 m/s, 0.07 m/s, 0.08 m/s, 0.09 m/s, 0.1 m/s, 0.2 m/s, 0.3 m/s, 0.4 m/s, 0.5 m/s, 0.6 m/s, 0.7 m/s, 0.8 m/s, 0.9 m/s, 1 m/s, 2 m/s, 3 m/s, 4 m/s, 5 m/s, or more. The plurality of feedstock speeds may be at most about 5 m/s, 4 m/s, 3 m/s, 2 m/s, 1 m/s, 0.9 m/s, 0.8 m/s, 0.7 m/s, 0.6 m/s, 0.5 m/s, 0.4 m/s, 0.3 m/s, 0.2 m/s, 0.1 m/s, 1 m/s, 0.09 m/s, 0.08 m/s, 0.07 m/s, 0.06 m/s, 0.05 m/s, 0.04 m/s, 0.03 m/s, 0.02 m/s, 0.01 m/s, or less. Alternatively, both the first roller and the second roller may be coupled to a first actuator and a second actuator, respectively, to direct their rotation. The first roller and the second roller may be separated by a gap (or space) to permit the feedstock to be directed through the gap. The gap may be greater than the cross-sectional dimension of the feedstock. A size of the gap may be adjustable by a gap adjusting mechanism. The gap adjusting mechanism may be coupled to the first roller, the second roller, or both. A controller may be operatively coupled to the gap adjusting mechanism. The controller may direct movement of the first roller and/or the second roller to adjust the size of the gap while the feedstock is directed towards or away from the guide. The first roller and the second roller may rotate in different directions while the feedstock is directed towards or away from the guide. In some examples, the system may comprise a plurality of assemblies. The system may include at least 1, 2, 3, 4, 5, 6, 7, 8, 9, 10, or more assemblies. The system may include at most 10, 9, 8, 7, 6, 5, 4, 3, 2, or 1 assembly.

The system may include the assembly adjacent to a feedstock source. The assembly may be a pusher assembly (i.e., a “slave” assembly) that pushes the feedstock from the feedstock source towards to guide. In some cases, the system may include a plurality of the assembly for each feedstock source of a plurality of feedstock sources. Alternatively or in addition to, the system may include an additional assembly adjacent to the guide. The additional assembly may be a puller assembly (i.e., a “master” assembly) that pulls the feedstock into the guide.

The first roller of the assembly may have a groove to accept at least a portion of the feedstock. The groove of the first roller may be V-shaped when viewed in cross-section (i.e., a V-groove roller). An angle between two sides of the V-groove may be no more than 160 degrees apart. The angle between the two sides of the V-groove may be at most about 150 degrees, 140 degrees, 130 degrees, 120 degrees, 110 degrees, 100 degrees, 90 degrees, 80 degrees, 70 degrees, 60 degrees, 50 degrees, 40 degrees, 30 degrees, 20 degrees, 10 degrees or less apart. The angle between the two sides of the V-groove may be at least about 10 degrees, 20 degrees, 30 degrees, 40 degrees, 50 degrees, 60 degrees, 70 degrees, 80 degrees, 90 degrees, 100 degrees, 110 degrees, 120 degrees, 130 degrees, 140 degrees, 150 degrees, or more apart. The groove may be other than V-shaped. In some cases, the groove may be U-shaped (i.e., a U-groove roller). A distance between two parallel walls of the U-groove may be at least 1 percent (%), 2%, 3%, 4%, 5%, 6%, 7%, 8%, 9%, 10%, or greater than a cross-sectional width of the feedstock. A distance between two parallel walls of the U-groove may be at most 10%, 9%, 8%, 7%, 6%, 5%, 4%, 3%, 2%, 1%, or less than a cross-sectional width of the feedstock. A radius of curvature of the U-groove may be substantially the same as a radius of curvature of the feedstock. The radius of curvature of the U-groove may deviate from the radius of curvature of the feedstock by at most about 30%, 25%, 20%, 15%, 10%, 5%, 4%, 3%, 2%, 1% or less. The radius of curvature of the U-groove may deviate from the radius of curvature of the feedstock by at least about 1%, 2%, 3%, 4%, 5%, 10%, 15%, 20%, 25%, 30%, or more.

A surface of the groove of the first roller may be partially or entirely smooth, knurled, or serrated to adjust contact surface area and/or frictional force between the surface and the feedstock. In some cases, the surface of the groove of the first roller may be coated with at least one polymeric material. Examples of the at least one polymeric material include one or more of poly(1,3-butadiene), (butyl acrylate), poly(ethyl acrylate), poly(ethylhexyl acrylate), and poly(n-octyl acrylate), polyvinyl chloride (PVC), polystyrene (PS), polymethyl methacrylate (PMMA), co-poly(styrene acrylonitrile), polymethacrylonitrile (PMAN), co-poly(vinyl chloride-vinyl acetate), co-poly(methyl methylacrylate-ethyl acrylate, terpoly(methyl methacrylate-acrylonitrile-styrene), and mixtures thereof. In some cases, the at least one polymeric material may be a composite that includes a plurality of metal, ceramic, and/or polymeric particles.

The first roller may include at least one additional groove adjacent to the groove. The at least one additional groove may be arranged in a parallel fashion to the groove. The at least one additional groove may accept at least a portion of at least one additional feedstock. The groove and the at least one additional groove may have different dimensions (e.g., widths, depths, etc.) and/or geometries (e.g., a V-groove, U-groove, etc.). The first roller may include at least 1, 2, 3, 4, 5, 6, 7, 8, 9, 10, or more additional grooves. The first roller may include at most 10, 9, 8, 7, 6, 5, 4, 3, or 2 additional grooves.

The first roller comprising the at least one additional groove may be coupled (e.g., mechanically attached) to a position adjusting mechanism. The position adjusting mechanism may move the first roller into and out of alignment with the feedstock or the at least one additional feedstock. The position adjusting mechanism may be one or more actuators (e.g., one or more linear screw actuators). The position adjusting mechanism may be a manual user operation or the controller automated process. In some cases, the controller may be in communication with the position adjusting mechanism to direct the position adjusting mechanism to move the first roller during the alignment with the feedstock or the at least one additional feedstock. In some examples, the position adjusting mechanism comprises a stage for holding at least the driver roller. The stage may further have one or more linear actuators that are mechanically attached to the stage.

The second roller of the assembly may be configured to (i) come in contact with at least a portion of the feedstock and (ii) direct the at least the portion of the feedstock into the groove of the first roller. A tip of the protrusion of the second roller may be configured to come in contact with the at least the portion of the feedstock. The tip of the protrusion of the second roller may be flat, curved, or any other shape that is suitable to accommodate different shapes and/or dimensions of the feedstock. A surface of the circumference of the second roller may be flat. In some cases, the surface of the circumference of the second roller may comprise a protrusion that is configured to direct the at least the portion of the feedstock into the groove of the first roller of the assembly. The protrusion may have a shape that corresponds to the shape of the groove of the first roller. The dimension of the protrusion of the second roller may be substantially the same as the dimension of the groove of the first roller. The dimension of the protrusion of the second roller may be different. The dimension of the protrusion of the second roller may deviate from the dimension of the groove of the first roller by at least aboutl percent (%). The dimension of the protrusion of the second roller may deviate from the dimension of the groove of the first roller by at least about 1%, 2%, 3%, 4%, 5%, 10%, 15%, 20%, 25%, 30%, 35%, 40%, 45%, 50%, or more. The dimension of the protrusion of the second roller may deviate from the dimension of the groove of the first roller by at most about 50%, 45%, 40%, 35%, 30%, 25%, 20%, 15%, 10%, 5%, 4%, 3%, 2%, 1%, or less.

The surface of the circumference of the second roller (e.g., flat or protruded) may be partially or entirely smooth, knurled, or serrated to adjust contact surface area and/or frictional force between the surface and the feedstock. In some cases, the surface of the circumference of the second roller may be coated with at least one polymeric material. Examples of the at least one polymeric material include one or more of poly(1,3-butadiene), (butyl acrylate), poly(ethyl acrylate), poly(ethylhexyl acrylate), and poly(n-octyl acrylate), polyvinyl chloride (PVC), polystyrene (PS), polymethyl methacrylate (PMMA), co-poly(styrene acrylonitrile), polymethacrylonitrile (PMAN), co-poly(vinyl chloride-vinylacetate), co-poly(methyl methylacrylate-ethyl acrylate, terpoly(methyl methacrylate-acrylonitrile-styrene), and mixtures thereof In some cases, the at least one polymeric material may be a composite that includes a plurality of metal, ceramic, and/or polymeric particles.

In some cases, the first roller with the groove may be a driver roller that is coupled to an actuator that subjects the driver roller to rotate and direct the feedstock towards the guide. The second roller, with or without the protrusion, may be a preload roller that presses at least a portion of the feedstock towards the driver roller. In some cases, the second roller, with or without the protrusion, may be a driver roller that is coupled to an actuator that subjects the driver roller to rotate and direct the feedstock towards the guide. The first roller with the groove may be a preload roller that presses at least a portion of the feedstock towards the driver roller.

The driver roller may be configured to (i) come in contact with at least a portion of the feedstock and (ii) rotate to direct the feedstock towards the guide of the print head. The driver roller may be coupled (e.g., mechanically attached) to the actuator that subjects the driver roller to rotation. The actuator may be a rotational actuator or an electric motor. Such rotation may feed the feedstock along a direction away from the feedstock source towards the guide. Alternatively or in addition to, the rotation may direct the feedstock along a direction away from the guide towards the feedstock source. The actuator may rotate the driver roller at a plurality of rotating speeds. The actuator may be configured to accelerate, decelerate, maintain at a given speed of the plurality of rotating speeds, or control a direction of rotation of the driver roller. The actuator may be in communication with the controller. The controller may direct the actuator to rotate the driver roller. In some cases, the actuator of the driver roller may comprise an encoder. The controller may be operatively coupled to the encoder of the actuator of the driver roller to monitor operating velocities of the driver roller.

In some examples, the system comprises a plurality of driver rollers. The system may include at least 2, 3, 4, 5, 6, 7, 8, 9, 10, or more driver rollers. The system may include a most 10, 9, 8, 7, 6, 5, 4, 3, or 2 driver rollers. Each driver roller of the plurality of driver rollers may be independently coupled to an actuator for subjecting a rotational movement, and each actuator may be independently or collectively in communication with one or more controllers.

The preload roller may be configured to (i) come in contact with at least a portion of the feedstock at a position adjacent to the driver roller and (ii) direct the at least the portion of the feedstock towards the driver roller. The preload roller may comprise an outer shell and an inner shell. The outer shell and the inner shell may move independently from each other. An outer circumference of the outer shell may come in contact with the portion of the wire. The preload roller may further comprise a bearing assembly disposed between the outer shell and the inner shell. The bearing assembly may facilitate the rotational motion of the outer shell with respect to the inner shell during directing the portion of the feedstock towards or away from the guide. The bearing assembly may facilitate the outer shell to roll with very little rolling resistance. A rolling element in the bearing assembly may be a ball bearing, a roller bearing, a gear bearing, etc. The bearing assembly may be lubricated with a viscous lubricant to facilitate the rotational motion of the outer shell of the preload roller. The viscous lubricant may remain inside the bearing assembly.

In some examples, the system comprises a plurality of preload rollers. The system may include at least 2, 3, 4, 5, 6, 7, 8, 9, 10, or more preload rollers. The system may include at most 10, 9, 8, 7, 6, 5, 4, 3, or 2 preload rollers.

A traction force may be required to direct the feedstock towards the guide. Thus, the gap between the driver roller and the second roller may be sufficiently small so that the feedstock is (i) in contact with the two rollers and (ii) compressed between the two rollers. The normal force due to compression and the friction between the feedstock and the driver roller may produce the traction force at one or more contact surfaces between the feedstock and the driver roller. The traction force may be a contact force. The traction force in combination with the rotation of the driver roller may be sufficient to direct movement of the feedstock towards or away from the guide.

Using an assembly comprising a preload roller having a protrusion and a driver roller having a V-groove, normal forces at the feedstock-V-groove contact surfaces can be calculated as a function of the V-groove angle (θ). A traction force (F_{Traction}) may be the total force applied axially to the feedstock by the driver roller. There may be two contact surfaces between the feedstock and the V-groove of the driver roller. Each of the two contact surfaces may experience a normal force (F_{Normal}) that is generated by a force exerted by the preload roller (F_{preload}). As such, the normal force (F_{Normal}) multiplied by the static coefficient of friction (μ_{Static}) may provide half of the traction force (F_{Traction}) exerted on the feedstock. The normal force (F_{Normal}) on each of two contact points of the V-groove may be equal to the preload force (F_{preload}) divided by 2 times the sine of half the angle of the V-groove. Thus, the maximum traction force (F_{Traction}) may be illustrated as shown in Equation 3:

$${F}_{Traction} = 2 \times {F}_{N o r m a l} \times {μ}_{Static} = 2 \times [ \frac{{F}_{Preload}}{2 \times sin ( \frac{θ}{2} )} ] \times {μ}_{Static} \qquad ( Equation 3 )$$

If the preload force exerted on the feedstock exceeds the normal force at the surface of the groove of the driver roller, there may be wear and fretting of the feedstock, the driver roller, and/or the preload roller.

The assembly comprising the driver roller and the preload roller may further comprise a gap adjusting mechanism that adjusts a size of a gap between the driver roller and the preload roller. The gap adjusting mechanism may be coupled to the preload roller, the driver roller, or both. The gap adjusting mechanism may help vary a force exerted by the preload roller, the driver roller, or both to at least a portion of the feedstock while directing the at least the portion of the feedstock towards or away from the guide.

The gap adjusting mechanism may be a pivot arm. The preload roller may be mounted to the pivot arm. One end of the pivot arm may be secured to a structure of the 3D printing system with a pivot shaft. The pivot arm may rotate about the pivot shaft to direct movement of the preload roller towards and away from the driver roller, thereby adjusting the gap between the preload roller and the driver roller. A biasing device (e.g., a spring) may be connected to a position along a length of the pivot arm to provide a biasing force to the pivot arm. The biasing device may include a biasing controller (e.g., a bolt) that can be used to adjust a force exerted by the biasing device to the pivot arm. The force of the biasing device may be adjusted by tightening or loosening the biasing controller, thereby adjusting the size of the gap between the preload roller and the driver roller. Alternatively or in addition to, the driver roller may be mounted to an additional pivot arm. The additional pivot arm may rotate about an additional pivot shaft, and its rotation may be adjusted by an additional biasing controller.

The gap adjusting mechanism may be an actuator that is mechanically coupled to the preload roller. The actuator may direct movement of the preload roller to adjust the size of the gap between the preload roller and the driver roller. The actuator may include an electric, hydraulic or pneumatic motor, or a linear actuator. The gap adjusting mechanism may be operatively coupled to the controller. The controller may direct movement of the gap adjusting mechanism to adjust the size of the gap. In some cases, the gap adjusting mechanism may be a rotational actuator. The rotational actuator may be operated by an operating current directed from the power source. The preload roller may be mounted eccentrically with respect to an axis of rotation of the rotational actuator (e.g., a center of a driver shaft of the rotational actuator). Thus, when the rotational actuator rotates by a certain degree, the preload roller may effectively (i) pivot about the axis of rotation of the rotational actuator, (ii) move towards or away from the driver roller, and (iii) adjust the size of the gap between the preload roller and the driver roller. Examples of the rotational actuator include a servomotor, brushed electric motor, brushless electric motor (e.g., stepper motor), servomotor, torque motor, and shaft actuator (e.g. hollow shaft actuator).

A center of the preload roller may be offset from the axis of rotation of the rotational actuator used as the gap adjusting mechanism by about 0.1 mm to about 10 mm. The center of the preload roller may be offset from the axis of rotation of the rotational actuator by at least about 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, 6 mm, 7 mm, 8 mm, 9 mm, 10 mm or more. The center of the preload roller may be offset from the axis of rotation of the rotational actuator by at most about 10 mm, 9 mm, 8 mm, 7 mm, 6 mm, 5 mm, 4 mm, 3 mm, 2 mm, 1.9 mm, 1.8 mm, 1.7 mm, 1.6 mm, 1.5 mm, 1.4 mm, 1.3 mm, 1.2 mm, 1.1 mm, 1.0 mm, 0.9 mm, 0.8 mm, 0.7 mm, 0.6 mm, 0.5 mm, 0.4 mm, 0.3 mm, 0.2 mm, 0.1 mm or less. Alternatively or in addition to, the center of the preload roller may be offset from the axis of rotation of the rotational actuator by about 0.1% to 99% of a radius of the rotational actuator. The center of the preload roller may be offset from the axis of rotation of the rotational actuator by at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, 80%, 90%, 99% or more. The center of the preload roller may be offset from the axis of rotation of the rotational actuator by at most about 99% 90%, 80%, 70%, 60%, 50%, 40%, 30%, 20%, 10 9%, 8%, 7%, 6%, 5%, 4%, 3%, 2%, 1%, 0.9%, 0.8%, 0.7%, 0.6%, 0.5%, 0.4%, 0.3%, 0.2%, 0.1% or less.

The rotational actuator used as the gap adjusting mechanism may be configured to rotate clockwise and counterclockwise. The rotational actuator may be configured to rotate by an increment of about 0.01 degrees to about 10 degrees. The rotational actuator may rotate by an increment of at least about 0.01 degrees, 0.02 degrees, 0.03 degrees, 0.04 degrees, 0.05 degrees, 0.06 degrees, 0.07 degrees, 0.08 degrees, 0.09 degrees, 0.1 degrees, 0.2 degrees, 0.3 degrees, 0.4 degrees, 0.5 degrees, 0.6 degrees, 0.7 degrees, 0.8 degrees, 0.9 degrees, 1 degrees, 2 degrees, 3 degrees, 4 degrees, 5 degrees, 6 degrees, 7 degrees, 8 degrees, 9 degrees, 10 degrees, or more. The rotational actuator may rotate by an increment of at most about 10 degrees, 9 degrees, 8 degrees, 7 degrees, 6 degrees, 5 degrees, 4 degrees, 3 degrees, 2 degrees, 1 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees, 0.08 degrees, 0.07 degrees, 0.06 degrees, 0.05 degrees, 0.04 degrees, 0.03 degrees, 0.02 degrees, 0.01 degrees or less. The rotational actuator may be operatively coupled to the controller. The controller may direct rotation of the rotational actuator to adjust the size of the gap.

The rotational actuator used as the gap adjusting mechanism may generate a torque. The torque generated by the rotational actuator may direct the preload roller to apply a force on the feedstock. The torque of the rotational actuator may be proportional to the force of the preload roller. The rotational actuator may be operatively coupled to the power source and the controller. The controller may direct the power source to provide electrical current to the rotational actuator to generate a torque. The torque generated by the rotational actuator may be proportional to the amount of current drawn from the power source, according to Equation 4:

T=Kₜ·I (Equation 4)
where T is the torque exerted by the rotational actuator,
I is the current drawn by the rotational actuator, and
Kₜ is a constant that defines a linear relationship between T and I.

The torque of the rotational actuator may range between about 1 millinewton meter (mN·m) and about 1000 mN·m. The torque of the rotational actuator may be at least about 1 mN·m, 2 mN·m, 5 mN·m, 10 mN·m, 20 mN·m, 50 mN·m, 100 mN·m, 200 mN·m, 500 mN·m, 1000 mN·m, or more. The torque of the rotational actuator may be at most about 1000 mN·m, 500 mN·m, 200 mN·m, 100 mN·m, 50 mN·m, 20 mN·m, 10 mN·m, 5 mN·m, 2 mN·m, 1 mN·m, or less.

The force applied by the preload roller to the feedstock may range between about 0.1 newton (N) to about 200 N. The force applied by the preload roller to the feedstock may be at least about 0.1 N, 0.2 N, 0.5 N, 1 N, 2 N, 5 N, 10 N, 20 N, 50 N, 100 N, 200 N, or more. The force applied by the preload roller to the feedstock may be at most about 200 N, 100 N, 50 N, 20 N, 10 N, 5 N, 2 N, 1N, 0.5 N, 0.2 N, 0.1 N, or less.

The rotational actuator may comprise a current sensor. The current sensor may be an electrical measurement meter (e.g., a voltmeter, ammeter, potentiometer, etc.) electrically coupled to the rotational actuator. The controller may be operatively coupled to the current sensor to record the operating current of the rotational actuator. The operating current of the rotational actuator may be an indication of a contact force between the preload roller and the feedstock.

The rotational actuator may comprise a rotary sensor (e.g, a resolver, encoder, etc.) that is operatively coupled to the controller. Examples of the encoder include an optical encoder and a rotary encoder. The rotary sensor of the rotational actuator may provide position and/or speed feedback. In some cases, the controller may use the rotary sensor to track rotation of the rotational actuator while the rotational actuator is turning to direct the preload roller to be in contact with the feedstock. In some cases, the controller may use the rotary sensor to detect any change in the angular position of the rotational actuator while the rotational actuator is directing the at least the portion of the feedstock towards the driver roller.

In some cases, the rotational actuator may operate under a constant current, thus a constant torque, and variable angular positions. The constant torque from the rotational actuator may direct the preload roller to apply a constant force on the at least the portion of the feedstock. In some cases, the rotational actuator may operate under a constant angular position and variable currents, thus variable torques. The constant angular position of the rotational actuator may promote a constant size of the gap between the preload roller and the driver roller. In an example, when the load from the feedstock increases during operation, rotational actuator may draw more current from the power source to apply a respectively increased torque to maintain the constant angular position.

Depending on the type of the feedstock (e.g., different sizes and/or different stiffness), a suitable operating current (current limit) of the rotational actuator may be determined. The suitable operating current may be proportional to a suitable operating force that is to be applied by the preload roller to the feedstock during directing the at least the portion of the feedstock. For example, a user may input the suitable operating current of each type of feedstock into the controller that is operatively coupled to the rotational actuator. In another example, the spool of the feedstock may have a barcode. A barcode reader operatively coupled to the controller may scan the barcode of the spool of the feedstock, and determine the suitable operating current that is assigned to the scanned barcode. Following determination of the suitable operating current, the rotational actuator may rotate until the connected preload roller comes in contact with the feedstock and, subsequently, the current of the rotational actuator reaches the suitable operating current for the feedstock. Once the suitable operating current is met, the power source may maintain the suitable operating current during feeding the feedstock to the guide, thereby maintaining a constant force exerted by the preload roller to the feedstock. In some cases, the rotational actuator may allow a change in the angular position to maintain the suitable operating current.

During loading the preload roller onto the feedstock, the current sensor of the rotational actuator may detect when the operating current of the rotational actuator increase rapidly prior to reaching the suitable operating current. At the same time, the rotary sensor of the rotational actuator may monitor a change in the angular position of the rotational actuator. The angular distance traveled by the rotational actuator when the operating current of the rotational actuator increases rapidly may be used to determine the size of the gap between the preload roller and the driver roller when the preload roller makes an initial contact with the feedstock. The size of the gap during the initial contact between the preload roller and the feedstock may be approximately equal to a cross-sectional dimension of the feedstock. Thus, the rotational actuator of the gap adjusting mechanism may dynamically measure the feedstock cross-sectional dimensions (e.g. diameters).

During directing at least a portion of the feedstock towards or away from the guide, the rotational actuator used as gap adjusting mechanism may be configured to maintain a fixed angular position, thereby maintaining the size of the gap constant. In some cases, a change in a diameter of the feedstock may require a change in the operating current of the rotational actuator to (i) adjust the torque exerted by the rotational actuator to the preload roller, (ii) adjust the force exerted by the preload roller to the feedstock, and (iii) maintain the size of the gap constant. In an example, if the diameter of the feedstock increases, the rotational actuator may draw more current to exert a greater force on the feedstock and maintain the size of the gap constant. In some cases, a change in stiffness of the feedstock may require a change in the operating current of the rotational actuator to (i) adjust the torque exerted by the rotational actuator to the preload roller, (ii) adjust the force exerted by the preload roller to the feedstock, and (iii) maintain the size of the gap constant. In an example, if the stiffness of the feedstock increases (e.g., changing to a feedstock of a stiffer material), the rotational actuator may draw more current to exert a greater force on the feedstock and maintain the size of the gap constant. Thus, the operating current of the rotational actuator necessary to maintain the size of the gap constant may be an indication of the forces involved during directing the feedstock towards or away from the guide. The forces many include the preload force exerted on the feedstock or the contact force between the feedstock and the driver roller.

In some cases, when the diameter and/or stiffness of the feedstock changes, it may be desirable to dynamically change the size of the gap, thereby maintaining the forces exerted on the feedstock approximately constant. This may help prevent any significant damage on the feedstock and/or the rollers from exerting excessive forces between the feedstock and the rollers. This may also help prevent slippage of the feedstock due to (i) any excessive force from the preload roller that pushes the feedstock out of the gap (ii) insufficient force from the preload roller to keep the feedstock in the gap. In an example, when the diameter and/or stiffness of the feedstock changes, the operating current of the rotational actuator may change in order to keep the size of the gap constant. By using the current sensor of the rotational actuator, the controller may be able to detect when the operating current of the rotational actuator is adjusted to maintain the size of the gap constant. If the controller detects a change in the operating current, the controller may dynamically readjust the operating current to allow a change in the size of the gap, thereby maintaining the forces exerted on the feedstock approximately constant or within an acceptable range that does not damage the feedstock or the rollers.

The controller, the preload roller, the rotational actuator coupled to the preload roller, and the current sensor and/or the rotary sensor of the rotational actuator may form a real-time closed-loop feedback communication to control the force exerted on the feedstock. The real-time closed-loop feedback communication may allow automated use of a wide range of feedstock dimensions and feedstock materials without damaging the feedstock or the assembly components. The real-time closed-loop feedback communication may allow: (1) dynamic compatibility with feedstocks of varying cross-sectional dimensions; (2) dynamic compatibility with feedstocks of varying materials and/or stiffness; (3) dynamic measurement of the feedstock cross-sectional dimension; (4) prevention or reduction of feedstock slippage from the gap; and (5) increasing life span of the rollers. The real-time closed-loop feedback communication may prevent at least some of print failures due to failed feedstock feeding to improve print quality.

Alternatively or in addition to, the gap adjusting mechanism may be a gap adjusting actuator that is mechanically coupled to the driver roller. The gap adjusting actuator may be operatively coupled to the controller. In some cases, the gap adjusting actuator may be a rotational actuator. The driver roller may be mounted eccentrically with respect to an axis of rotation of the rotational actuator. The rotational actuator may be operated by a current from the power source, and the rotational actuator may comprise a current sensor to measure its operating current. The rotational actuator may comprise a rotary sensor. The controller, the driver roller, the rotational actuator coupled to the driver roller, and the current sensor and/or the rotary sensor of the rotational actuator may form a real-time closed-loop feedback communication to control the force exerted on the feedstock.

In some cases, each of the preload roller and the driver roller may comprise a gap adjusting mechanism. The gap adjusting mechanisms of the preload roller and the driver roller may be in communication with each other.

The system may comprise an optical sensor to measure the diameter of at least a portion of the feedstock before the at least the portion of the feedstock is fed through the assembly comprising the preload roller, the driver roller, and the gap adjusting mechanism that adjusts the size of the gap between the two rollers. The optical sensor may be configured between the assembly and the feedstock source. The optical sensor and the assembly may be operatively coupled to the controller. In an example, the optical sensor may be a camera that captures an image of the at least the portion of the feedstock and calculates the approximate diameter of the at least the portion of the feedstock. According to the calculated diameter of the at least the portion of the feedstock, the controller may direct the gap adjusting mechanism to adjust the gap between the two rollers, thereby maintaining the forces exerted on the feedstock approximately constant.

In some cases, the preload roller may comprise a rotary sensor (e.g, a resolver, encoder, etc.) that is operatively coupled to the controller. Examples of the encoder include an optical encoder and a rotary encoder. The encoder may be an auxiliary encoder. The rotary sensor of the preload roller may provide position and/or speed feedback. In some cases, the controller may use the rotary sensor to track rotation of preload roller and determine a length of the feedstock that is fed through the gap between the preload roller and the driver roller. In some cases, the controller may detect when the preload roller rapidly stops rotating, which may indicate slippage of the feedstock away from the gap.

In some cases, the preload roller may comprise a force sensor to measure a contact force between the preload roller and the feedstock. The outer shell of the preload roller may comprise an encoder disc that is responsive to an exerted pressure, and the inner shell of the preload roller may comprise an encoder sensor that can measure and record the response of the encoder disc to the exerted pressure. For example, the outer shell of the preload roller may comprise a piezoelectric disc that generates piezoelectricity in response to an applied pressure by the feedstock. The inner shell of the preload roller may comprise an encoder sensor that can measure and record the change in the piezoelectricity of the preload roller while the feedstock is fed through the assembly towards or away from the guide. A sudden drastic drop in the piezoelectricity may indicate a slippage of the feedstock from the gap between the preload roller and the driver roller.

FIG. 1A-1D schematically illustrate an example of a wire feeding assembly 101. The assembly 101 comprises a driver roller 110 and a preload roller 120 adjacent to the driver roller 110. The driver roller 110 may have a groove to receive a wire 135, and the preload roller 120 may have a protrusion to make contact with the wire 135. The preload roller 120 and the driver roller 110 are separated by a gap 130. A size of the gap 130 is adjustable to permit the wire 135 to be directed through the gap 130. The gap 130a in FIG. 1A illustrates an open gap where the preload roller 120 is not in contact with the wire 135. The gap 130b in FIG. 1B illustrates a closed gap where the preload roller 120 is in contact with at least a portion of the wire 135 and presses at least the portion of the wire 135 into a groove of the driver roller 110.

As shown in FIG. 1C, the driver roller 110 is coupled to an actuator 112. The actuator 112 may be configured to subject the driver roller 110 to rotation to direct the wire 135 towards a wire receiver 137. In a three-dimensional (3D) printing system, the wire receiver 137 may be a guide that directs the wire 135 towards a printing area. The actuator 112 of the driver roller 110 may comprise an encoder 114. The encoder 114 may monitor an operating rotational speed of the driver roller 110. The preload roller 120 is coupled to a gap adjusting actuator 140. The preload roller 120 is mounted eccentrically (further described in FIG. 1D) to a driver shaft of the gap adjusting actuator 140. The gap adjusting actuator 140 may rotate to adjust the size of the gap 130 between the driver roller 110 and the preload roller 120 (as previously shown in FIGS. 1A and 1B). The gap adjusting actuator 140 may be a rotational actuator (e.g., a servomotor). The gap adjusting actuator 140 may comprise a sensor (e.g, a resolver, encoder, etc.) that is operatively coupled to a controller 144. In some cases, the controller 144 may use the sensor to track an angular position of the gap adjusting actuator 140 while the gap adjusting actuator 140 is directing the preload roller 120 to be in contact with the wire 135. In some cases, the controller 144 may use the sensor to detect any change in the angular position of the gap adjusting actuator 140 during wire feeding. A current sensor 142 is coupled to the gap adjusting actuator 140 to measure an operating current of the gap adjusting actuator 140. The current sensor 142 may be an electrical measurement meter (e.g., a voltmeter, ammeter, potentiometer, etc.). The controller 144 controls operation of the gap adjusting actuator 140 and the current sensor 142. A real-time closed-loop feedback communication comprising the preload roller 120, the gap adjusting actuator 140, the current sensor 142, and the controller 144 may be formed to dynamically control the force exerted by the preload roller 120 to the wire 135 or the size of the gap 130 during wire feeding. In addition, the preload roller 120 comprises a bearing assembly 125. The bearing assembly 125 facilitates the rotational motion of the preload roller 120 independent of a rotation of the gap adjusting actuator 140 during feeding the wire 135 towards or away from the wire receiver 137 (e.g., a guide of a print head of a 3D printer). Furthermore, the preload roller 120 is coupled to an encoder disc 150 comprising encoder lines, and an auxiliary encoder 155 to read the encoder disc 150. The encoder disc 150 may move in conjunction with the preload roller 120. The auxiliary encoder 155 is positioned on a platform 157 that is coupled to the driver shaft of the gap adjusting actuator 140, and thus the auxiliary encoder 155 does not move in conjunction with the preload roller 120. The auxiliary encoder 155 may monitor the encoder disc 150 to measure movement of the preload roller 120. In some cases, the auxiliary encoder 155 may monitor the encoder disc 150 to measure slippage of the wire 135 from the preload roller 120 (e.g., when the preload roller 120 suddenly decelerates during operation).

FIG. 1D schematically illustrates a cross-sectional view of the preload roller 120 to demonstrate how the preload roller 120 is mounted eccentrically to a driver shaft of the gap adjusting actuator 140. As illustrated, a center 160 of the driver shaft of the gap adjusting actuator 140 (e.g., a rotational axis of a rotational actuator) is offset from a center of the preload roller 120 by 1.5 millimeter (mm).

In some cases, the gap adjusting actuator 140 (e.g., a rotational actuator) may operate under a constant current, thus a constant torque, and variable angular positions. The constant torque from the gap adjusting actuator 140 may direct the preload roller 120 to apply a constant force on the at least the portion of the wire 135. In some cases, the gap adjusting actuator 140 may operate under a constant angular position and variable currents, thus variable torques. The constant angular position of the gap adjusting actuator 140 may promote a constant size of the gap 130 between the preload roller 120 and the driver roller 110.

FIG. 2 schematically illustrates how the rotation of the gap adjusting actuator 140 (e.g. a rotational actuator) changes the position of the preload roller 120. As described previously, the preload roller 120 is mounted eccentrically to the center 160 of the driver shaft of the gap adjusting actuator 140 (e.g., a rotational axis of a rotational actuator) by a distance 205 (e.g., 1.5 mm). In an example, when the rotational actuator rotates about its rotational axis 160, the center of the preload roller may be changed to positions 210, 220, 230, or more.

FIG. 3 is a graph 301 of a change in an operating current of the gap adjusting actuator 140 (e.g., a rotational actuator) as a function of time while the gap adjusting actuator 140 moves to direct its connected preload roller 120 towards the wire 135. Depending on the type of the wire 135 (e.g., different materials, sizes, and/or different stiffness), a suitable operating current 305 of the gap adjusting actuator 140 may be predetermined. The suitable operating current 305 may be proportional to a suitable operating force that is to be applied by the preload roller 120 to the wire 135 during wire feeding. Once the preload roller 120 comes in contact with the wire 135 (the time at which the contact is made is indicated as 310 in FIG. 3), the wire 135 exerts a load to the preload roller 120, and thereby to the connected gap adjusting actuator 140. As such, the gap adjusting actuator 140 draws more current from a power source to apply a greater torque (force) back to the wire 135. Thus, an increase in the actual operating current 315 may be an indication that the preload roller 120 has come in contact with the wire 135. The controller 144 that is operatively coupled to the gap adjusting actuator 140 may be programmed to terminate movement of the gap adjusting actuator 140 once the actual operating current 315 of the gap adjusting actuator 140 reaches the suitable operating current 305 that is predetermined according to the wire 135. In addition, while the gap adjusting actuator 140 is moving to direct the preload roller 120 towards the wire 135, the controller 144 may use the encoder that is coupled to the gap adjusting actuator 140 to determine a change in its angular position, and thus the position 320 of the preload roller 120 relative to the driver roller 110.

FIG. 4 schematically illustrates an example of a 3D printing system (“system”) 401. The system 401 comprises a platform 405 for holding the 3D object 408 during printing. The system 401 also comprises a wire source 410 configured to hold a wire 415. The wire 415 is usable for printing at least a portion of a larger 3D object or an entirety of the 3D object. The system 401 comprises a print head comprising a guide 420, which directs the wire 415 towards and in contact with the support 405 or a portion of the 3D object 408 adjacent to the support 405. The system includes a roller 412 to provide tension on the wire 415 during wire feeding. The system includes a first wire feeding assembly 430 for pushing the wire 415 from the wire source 410 towards the guide 420. The first wire feeding assembly 430 may be an embodiment of the aforementioned wire feeding assembly 101, as illustrated in FIG. 1A-1D. The first wire feeding assembly 430 may be a pusher assembly or a “slave” assembly. For example, the pusher assembly 430 comprises a driver roller 435 with a groove 440. The first wire feeding assembly 430 also comprises a preload roller 445 that pushes the wire 415 into the groove 440 of the driver roller 435. The system also includes a second wire feeding assembly 450 for pulling the wire 415 into the guide 420. The second wire feeding assembly 450 may provide tension on the wire 415 as it is fed into the guide 420. The second wire feeding assembly 450 may be an embodiment of the aforementioned wire feeding assembly 101, as illustrated in FIG. 1A-1D. The second wire feeding assembly 450 may be a puller assembly or a “master” assembly. For example, the second wire feeding assembly 450 comprises a driver roller 455 with a groove 460. The second wire feeding assembly 450 also comprises a preload roller 465 that pushes the wire 415 into the groove 460 of the driver roller 455. The system 401 also comprises a power source 470 to power various components of the system 401, as well as a controller 480 to direct the power source 470 to power various components of the system 401.

In another aspect, the present disclosure provides a method for printing a 3D object. The method may comprise activating a 3D printing system. The 3D printing system may comprise a wire source configured to hold a wire. The wire may be usable for printing said 3D object. The 3D printing system may comprise a print head comprising a guide. The 3D printing system may comprise a support to hold at least a portion of the 3D object. The 3D printing system may comprise a driver roller configured to come in contact with the wire. The driver roller may be coupled to an actuator that is configured to subject the driver roller to rotation. The rotation of the driver roller may direct the wire towards the guide. The 3D printing system may comprise a preload roller. The preload roller may be adjacent to the driver roller. The preload roller may be configured to come in contact with the wire at a position (e.g., adjacent to the driver roller). The preload roller and the driver roller may be separated by a gap. A size of the gap may be adjustable to permit the wire to be directed through the gap. The method may comprise adjusting the size of the gap. The method may comprise using the actuator to direct the wire through the gap and towards the guide. The method may comprise supplying electrical current from the guide through the wire and to the support, or vice versa, during the printing under conditions sufficient to melt the wire when the wire is in contact with the support or the portion of the 3D object. The method may comprise supplying electrical current from the guide through the wire and to the support, or vice versa, during the printing under conditions sufficient to melt the wire when the wire is in contact with the support and the portion of the 3D object. The method may utilize various aspects of the aforementioned system for printing a 3D object, including a gap adjusting mechanism controlled by one or more actuators.

In another aspect, the present disclosure provides a method for printing a three-dimensional (3D) object adjacent to a support (e.g., base), comprising (a) receiving in computer memory a computational representation of the 3D object; (b) using a print head to initiate printing of the 3D object by, (i) directing at least one feedstock through a feeder towards the support and (ii) flowing electrical current through the at least one feedstock and into the support, or vice versa; (c) subjecting the at least one feedstock to heating upon flow of electrical current through the at least one feedstock and into the support, or vice versa, which heating is sufficient to melt at least a portion of the at least one feedstock; (d) depositing at least one layer of the at least the portion of the at least one feedstock or depositing the at least the portion of the at least one feedstock adjacent to the support in accordance with the computational representation of the 3D object, thereby printing the 3D object. In some embodiments, the method for printing the 3D object further comprises repeating (d) one or more times to deposit and shape additional portion(s) of the at least one feedstock or at least one other feedstock adjacent to the support. In some embodiments, the method for printing the 3D object further comprises subsequent to (d), changing a relative position of the one or more tips with respect to the at least one layer. A size of the at least the portion of the at least one feedstock may be controllable relative to the feedstock during deposition.

FIG. 6 schematically illustrates an example of a wire feeding method (“method”) 601. In this example, the wire feeding method is an embodiment for 3D printing method. The method comprises activating a 3D printing system (process 610). The 3D printing system comprises one or more components of the system for printing the 3D object, as provided herein. In an example, the 3D printing system may be an embodiment of the aforementioned wire feeding assembly 101, as illustrated in FIG. 1A-1D. Referring to FIG. 6, the method comprises supplying a wire (i.e., a feedstock) through a gap between a driver roller and a preload roller of the 3D printing system (process 620). The method comprises adjusting a size of the gap between the driver roller and the preload roller of the 3D printing system (process 630). The method comprises measuring a force exerted on the wire by the driver roller and/or the preload roller (process 640). The method comprises comparing the measured force (or a plurality of measured forces at one position on the wire disposed within the gap or at a plurality of positions on the wire disposed within the gap) to a threshold, and determining if the force is equal to, above, below, or within the threshold (process 650). The threshold may be a pre-determined threshold value or range of the force. The pre-determined threshold value may be a maximum value or a minimum value. Alternatively, the pre-determined threshold may comprise a plurality of values, such as the maximum and the minimum value, or a range of values. The threshold may be a force acceptable by the wire without experiencing a significant damage (e.g., deformation or cut). The threshold may vary depending on one or more operating conditions and/or process parameters. In some cases, the threshold may be updated in situ depending on one or more operating conditions and/or process parameters. The threshold may be a force acceptable by the driver roller and/or the preload roller without experiencing a significant damage (e.g., deformation or cut). The threshold may be specific for a type of material the wire is made of Alternatively or in addition to, the threshold may be a common threshold for different types of materials that different wires are made of. When the measured force exerted on the wire is above the threshold (process 650, NO), the method comprises adjusting the size of the gap (e.g., increasing the size) such that the force exerted on the wire is decreased. Alternatively, when the measured force exerted on the wire is equal to or below the threshold (process 650, YES), the method comprises using an actuator (e.g., an actuator coupled to the driver roller) to direct the wire through the gap and towards a guide (process 660). The guide is part of a print head of the 3D printing system. The method further comprises supplying electrical current from the guide through the wire and to the support (or vice versa), under conditions sufficient to melt the wire when the wire is in contact with the support or a portion of a 3D object (process 670).

In another aspect, the present disclosure provides a system for forming a 3D object. The system may comprise a first roller separated from a second roller by a gap. The gap may permit a wire to pass therethrough and in contact with a support. The gap may be an adjustable gap. The adjustable gap may permit the wire to pass therethrough and in contact with the support. The system may comprise a controller. The controller may direct supply of the wire through the gap (e.g., the adjustable gap) and in contact with the support. The controller may direct generation of heat from within the wire to melt at least a portion of the wire when the at least the portion of the wire is in contact with the support, to form the 3D object. The system may utilize various aspects of the aforementioned system for printing a 3D object, including a gap adjusting mechanism controlled by one or more actuators. In an example, the gap adjusting mechanism may be an embodiment of the aforementioned wire feeding assembly 101, as illustrated in FIG. 1A-1D.

The first roller and the second roller may be aligned relative to the wire such that the alignment between the first roller and the second roller may be perpendicular to a length of the wire. Alternatively, the alignment between the first roller and the second roller may not be perpendicular (e.g., greater than 90 degrees or less than 90 degrees) to the length of the wire. The gap between the first roller and the second roller may permit at least 1, 2, 3, 4, 5, 6, 7, 8, 9, 10, or more wires to pass therethrough and in contact with the support. The gap between the first roller and the second roller may permit at most 10, 9, 8, 7, 6, 5, 4, 3, 2, or 1 wire to pass therethrough and in contact with the support. The gap may permit a plurality of wires therethrough and in contact with a same portion of the support. Alternatively, the gap may permit a plurality of wires therethrough, and two or more wires of the plurality of wires may be in contact with different portions of the support.

The controller may be configured to adjust the gap between the first roller and the second roller. The controller may be direct movement of the first roller or the second roller relative to one another (e.g., towards or away from one another) to adjust the gap. Alternatively, the controller may direct to the first roller and the second roller relative to one another to adjust the gap.

The gap between the first roller and the second roller may be at least 0.5-fold, 0.6-fold, 0.7-fold, 0.8-fold, 0.9-fold, 1.0-fold, or greater than a cross-sectional dimension (e.g., a diameter) of the wire. The gap between the first roller and the second roller may be at most 1.0-fold, 0.9-fold, 0.8-fold, 0.7-fold, 0.6-fold, 0.5-fold, or less than the cross-sectional dimension of the wire. The directing of the wire through the gap between the first roller and the second roller may not deform at least a portion of the wire that is in contact with the first roller and/or the second roller. Alternatively, the directing of the wire through the gap between the first roller and the second roller may deform at least a portion of the wire that is in contact with the first roller and/or the second roller. In some cases, one or more layers (e.g., one or more polymeric layers) may be disposed between (i) the first roller and at least a portion of the wire and/or (ii) the second roller and at least a portion of the wire to adjust (e.g., decrease or increase) friction between each roller and the at least the portion of the wire. In some examples, the one or more layers may be disposed as coatings on a surface of the first roller and/or the second roller.

In some cases, the controller may direct the first roller or the second roller to direct the wire through the adjustable gap and in contact with the support. Movement of one of the first roller and the second roller, e.g., via the controller, may not indirectly induce movement of the other of the first roller and the second roller. Alternatively, movement of one of the first roller and the second roller, e.g., via the controller, may indirectly induce movement of the other of the first roller and the second roller. In some cases, the controller may direct the first roller and the second roller to direct the wire through the adjustable gap and in contact with the support.

In some cases, the system may further comprise a power supply. The power supply may be in electrical communication with the wire or the support. Alternatively, the power supply may be in electrical communication with the wire and the support. The controller may direct the power supply to supply electrical current from the wire to the support to generate the heat. The controller may direct the power supply to supply electrical current from the support to the wire to generate the heat. Examples of the power supply include, but are not limited to, a DC power supply, AC power supply, AC-to-DC power supply, switched-mode power supply, linear regulator, programmable power supply, uninterruptible power supply, high-voltage power supply, bipolar power supply, etc.

In another aspect, the present disclosure provides a method for forming a 3D object. The method may comprise providing a first roller separated from a second roller by a gap. The size of the gap may be fixed. Alternatively, the gap may be an adjustable gap. The method may comprise directing a wire through the adjustable gap and in contact with a support. The method may comprise using heat from within the wire to melt the wire when the wire is in contact with the support, to form the 3D object. The method may utilize various aspects of the aforementioned system and method for printing a 3D object, including a gap adjusting mechanism controlled by one or more actuators. In an example, the gap adjusting mechanism may be an embodiment of the aforementioned wire feeding assembly 101, as illustrated in FIG. 1A-1D. In another example, the gap adjusting mechanism may be an embodiment of the aforementioned method 601, as illustrated in FIG. 6. The method may further utilize various aspects of the aforementioned system for forming a 3D object, including a mechanism to adjust a gap between a first roller and a second roller.

### Computer Systems

The present disclosure provides a computer system 501 that is programmed to implement methods of printing a three-dimensional (3D) object in the present disclosure.

FIG. 5 shows a computer system 501 that is programmed or otherwise configured to communicate with and regulate various aspects of a 3D printer of the present disclosure. The computer system 501 can communicate with a power source, one or more actuators, or one or more sensors of the 3D printer. The computer system 501 can direct the power source to supply electrical current to a feedstock for use in printing a 3D object. The computer system 501 may also be programmed to communicate with one or more feedstock feeding assemblies. Each feedstock feeding assembly may comprise a driver roller and a preload roller, and the computer system 501 can be programmed to communicate with the driver roller and the preload roller independently or simultaneously. The computer system 501 can accelerate, decelerate, maintain at a given speed of a plurality of rotating speeds, or control a direction of rotation of the driver roller. The computer system 501 can be programmed to move the preload roller relative to the driver roller, adjust a size of a gap between the preload roller and the driver roller, or maintain a given size of the gap. By adjusting the size of the gap, the computer system 501 can control a force exerted on the feedstock.

The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, (i) activate or deactivate a 3D printer for printing a 3D object, (ii) determine a selected size of a gap between a preload roller and a driver roller of a plurality of feedstock feeding assemblies, or (iii) determine a selected pressure exerted by the gap to the feedstock. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1105. The algorithm can, for example, (i) assign a specific size of a gap between a preload roller and a driver roller of a plurality of feedstock feeding assemblies, or (ii) dynamically change the size of the gap to maintain a constant force exerted to the feedstock during feeding the feedstock for printing a 3D object.

### Wire Feeding Systems and Methods

In another aspect, the present disclosure provides a system for feeding a feedstock (e.g., a wire). The system may comprise a feedstock source configured to hold a wire. The system may comprise a driver roller configured to undergo rotation to direct the feedstock towards a feedstock receiver. The system may comprise a preload roller adjacent to the driver roller and configured to come in contact with the feedstock at a position adjacent to the driver roller. The preload roller and the driver roller may be separated by a gap. The size of the gap may be adjustable to permit the feedstock to be directed through the gap. The system may comprise an actuator coupled to the driver roller and/or the preload roller and configured to adjust the size of the gap. The system may comprise a controller operatively coupled to the actuator. The controller may be configured to (i) direct the actuator to adjust the size of the gap and (ii) subject the driver roller to rotation to direct the feedstock towards the wire receiver.

The system may utilize various aspects of the aforementioned system for printing a 3D object, including a gap adjusting mechanism controlled by an actuator. The driver roller and/or the preload roller may be mounted eccentrically with respect to an axis of rotation of the actuator. The actuator may comprise a current sensor to measure an operating current of the actuator. The actuator may comprise a sensor that detects movement of the actuator. The controller may be configured to provide a real-time closed-loop feedback communication between (i) the driver roller and/or the preload roller and (ii) the current sensor. In an example, the gap adjusting mechanism may be an embodiment of the aforementioned wire feeding assembly 101, as illustrated in FIG. 1A-1D.

In some cases, the feedstock receiver may a guide (e.g., a nozzle) of a welding unit (e.g., welding gun) for welding (e.g., gas metal arc welding, flux-cored arc welding, etc.). In some cases, the feedstock receiver may be a guide (e.g. a nozzle) of a printing head in a device for printing a 3D object. The feedstock may be usable for printing the 3D object. The feedstock may comprise at least one of polymers, metals, metal alloys, ceramics, or mixtures thereof. In some cases, the polymers may be thermoplastics. Examples of thermoplastics include acrylate or methylmethacrylate polymers or copolymers (e.g., polyacrylates, polymethylmethacrylates, etc.); polylactic acid (PLA) polymers; polyhydroxyalkanoate (PHA) polymers (e.g., polyhydroxybutyrate (PHB)); polycaprolactone (PCL) polymers; polyglycolic acid polymers; acrylonitrile-butadiene-styrene polymers (ABS); polyvinylidene fluoride polymers; polyurethane polymers; polyolefin polymers (e.g., polyethylene, polypropylene, etc.); polyester polymers; polyalkylene oxide polymers (e.g., polyethylene oxide (PEO)); polyvinyl alcohol (PVA) polymers; polyamide polymers; polycarbonate polymers; high impact polystyrene (HIPS) polymers; polyurethane polymers, or mixtures thereof.

In another aspect, the present disclosure provides a method of feeding a feedstock (e.g., a wire). The method may comprise activating a feedstock feeding system. The feedstock feeding system may comprise a feedstock source configured to hold a feedstock (e.g., a wire). The feedstock feeding system may comprise a driver roller configured to undergo rotation to direct the wire towards a feedstock receiver (e.g., a wire receiver). The feedstock feeding system may comprise a preload roller adjacent to the driver roller and configured to come in contact with the wire at a position adjacent to the driver roller. The preload roller and the driver roller may be separated by a gap. A size of the gap may be adjustable to permit the wire to be directed through the gap. The method may comprise adjusting the size of the gap. The method may comprise rotating the driver roller to direct the wire through the gap and towards the wire receiver. The method may utilize various aspects of the aforementioned method for printing a 3D object, including a gap adjusting mechanism controlled by an actuator. In an example, the gap adjusting mechanism may be an embodiment of the aforementioned method 601, as illustrated in FIG. 6.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-53. (canceled)

54. A system for feeding a wire, comprising:
a wire source configured to hold a wire;
a driver roller configured to undergo rotation to direct said wire towards a wire receiver;
a preload roller adjacent to said driver roller and configured to come in contact with said wire at a position adjacent to said driver roller, wherein said preload roller and said driver roller are separated by a gap, and wherein a size of said gap is adjustable to permit said wire to be directed through said gap;
an actuator coupled to said driver roller or said preload roller and configured to adjust said size of said gap; and
a controller operatively coupled to said actuator, wherein said controller is configured to (i) direct said actuator to adjust said size of said gap and (ii) subject said driver roller to rotation to direct said wire towards said wire receiver.

55. The system of claim 54, wherein said actuator is coupled to said driver roller and said preload roller.

56. The system of claim 54, wherein said driver roller or said preload roller is mounted eccentrically with respect to an axis of rotation of said actuator.

57. The system of claim 56, wherein said driver roller and said preload roller are mounted eccentrically with respect to an axis of rotation of said actuator.

58. The system of claim 54, wherein said actuator comprises a current sensor to measure an operating current of said actuator.

59. The system of claim 54, wherein said actuator comprises a sensor, wherein said sensor detects movement of said actuator.

60. The system of claim 54, wherein said controller is configured to provide a real-time closed-loop feedback communication between (i) said driver roller or said preload roller and (ii) said actuator.

61. The system of claim 60, wherein said controller is configured to provide said real-time closed-loop feedback communication between (i) said driver roller and said actuator and (ii) said preload roller and said actuator.

62. The system of claim 54, wherein said driver roller and said preload roller are configured to rotate in different directions while said wire is directed towards or away from said wire receiver.

63. The system of claim 54, wherein said driver roller further comprises an additional actuator, wherein said additional actuator is configured to subject said driver roller to rotation to direct said wire towards said wire receiver.

64. The system of claim 54, wherein said preload roller further comprises a sensor, wherein said sensor detects rotational movement of said preload roller.

65. The system of claim 54, wherein said wire receiver is a nozzle of a welding unit for wire welding.

66. The system of claim 54, wherein said wire receiver is a nozzle of a printing head in a device for printing a three-dimensional (3D) object, wherein said wire is usable for said printing said 3D object.

67. A method of feeding a wire, comprising:
(a) activating a wire feeding system, comprising:
i. a wire source configured to hold a wire;
ii. a driver roller configured to undergo rotation to direct said wire towards a wire receiver;
iii. a preload roller adjacent to said driver roller and configured to come in contact with said wire at a position adjacent to said driver roller, wherein said preload roller and said driver roller are separated by a gap, and wherein a size of said gap is adjustable to permit said wire to be directed through said gap; and
iv. an actuator coupled to said driver roller or said preload roller and configured to adjust said size of said gap;
(b) adjusting said size of said gap; and
(c) rotating said driver roller to direct said wire through said gap and towards said wire receiver.

68. The method of claim 67, wherein, in (a), said actuator is coupled to said driver roller and said preload roller.

69. The method of claim 67, further comprising using real-time closed-loop feedback to measure a force exerted on said wire by said driver roller or said preload roller.

70. The method of claim 69, further comprising using said real-time closed-loop feedback to measure said force exerted on said wire by said driver roller and said preload roller.

71. The method of claim 67, wherein said wire receiver is a nozzle of a welding unit for wire welding.

72. The method of claim 67, wherein said wire receiver is a nozzle of a printing head in a device for printing a three-dimensional (3D) object, wherein said wire is usable for said printing said 3D object.

73. The method of claim 72, further comprising supplying electrical current from said nozzle of said printing head through said wire and to a support, or vice versa, under conditions sufficient to melt said wire when said wire is in contact with said support or a portion of said 3D object, wherein said support is configured to hold at least said portion of said 3D object.
